(19) United States
(12) Patent Application Publication
(10) Pub. No.: US 2025/0333314 A1
(43) Pub. Date: Oct. 30, 2025

(54) COMPOSITE MATERIAL AND PREPARATION METHOD THEREFOR

(71) Applicant: YAAN BESTRY PERFORMANCE MATERIALS CORP., Yaan (CN)

(72) Inventors: Fuqiang ZHOU, Yaan (CN); Xiaodong LIU, Yaan (CN); Qi WU, Yaan (CN); Rutao XU, Yaan (CN); Lin TAO, Yaan (CN); Fan ZHONG, Yaan (CN); Cheng LU, Shanghai (CN); Liang CHEN, Shanghai (CN)

(21) Appl. No.: 19/258,741

(22) Filed: Jul. 2, 2025

Related U.S. Application Data
(63) Continuation-in-part of application No. PCT/CN2024/070438, filed on Jan. 3, 2024.

(30) Foreign Application Priority Data
Jan. 4, 2023 (CN) 202310007419.9

(51) Int. Cl. C01B 32/956

(52) U.S. Cl. CPC C01B 32/956; C01P 2002/72; C01P 2002/85; C01P 2002/90; C01P 2004/03; C01P 2004/51; C01P 2006/11; C01P 2006/12; C01P 2006/40

(57) ABSTRACT

A composite material and a preparation method therefor are provided. The composite material comprises an inner core and a shell coating the outside of the inner core, wherein the thermal conductivity of the inner core material is not less than 20 W/m·K, and the material of the shell comprises a first metal salt. The composite material satisfies the following conditions: D50₁ of the composite material is A, the composite material with a mass of M is placed in a container with a stirring device, is stirred for 10 min under the condition of a charging coefficient being 0.4 and 500 r/min, and then passes through a (0.1-0.3)×A sieve, and the amount of screen underflow is not higher than 0.05×M. The composite material can make up defects of the inner core material, the aging performance is relatively good, and the heat conductivity coefficient is also relatively high.

### CROSS-REFERENCE TO RELATED APPLICATION

The present application is a Bypass Continuation-in-Part of International Application No. PCT/CN2024/070438, filed on Jan. 3, 2024, which claims the priority to Chinese Patent Application No. CN202310007419.9, filed on Jan. 4, 2023, entitled “COMPOSITE MATERIAL AND PREPARATION METHOD THEREFOR,” the contents of which are incorporated herein by reference in entirety.

### TECHNICAL FIELD

The present disclosure relates to the technical field of composite materials, in particular to a composite material and a preparation method thereof.

### BACKGROUND ART

Thermal conductive fillers are fillers added to matrix materials (e.g., various thermal adhesive matrix materials) to increase the thermal conductivity of the materials. Common thermal conductive fillers include aluminum oxide, magnesium oxide, zinc oxide, aluminum nitride, boron nitride, silicon carbide, etc. Thermal conductive fillers are generally in powder form, and the powder of a single material may be added to the matrix material, or the powders of two or more single materials may be added to the matrix material to increase the thermal conductivity of the material.

However, the powder of a single material as a thermal conductive filler typically has certain defects. For example, silicon carbide is a semiconductor material with poor insulation. When added to a matrix material as a thermal conductive filler to form a thermal conductive mixture, if the thermal conductive mixture is to be used in the field of electronic products, it may have an adverse effect on the operation of the electronic products. For example, aluminum nitride has poor hydrolysis stability. When added to a matrix material as a thermal conductive filler to form a thermal conductive mixture, if the thermal conductive mixture is to be used in a high-humidity environment, its performance will be affected. For another example, silicon nitride has a high hardness. When added to a matrix material as a thermal conductive filler to form a thermal conductive mixture, during the use of the thermal conductive mixture, silicon nitride may cause wear on other devices in contact with silicon nitride, resulting in a decrease in the service life of the device.

CN105419301A discloses a composite thermal conductive filler and a manufacturing method thereof. A high thermal conductive powder is used as the shell of the composite powder, and another powder is used as the inner core. The two are combined into a composite powder by a physical integration process to serve as the thermal conductive filler. The materials forming the shell include ceramic materials such as nitride, boride, oxide, silicide, carbide, and composite oxide (hydrated metal silicate). They have good thermal conductivity and dielectric properties. The inner core material is inorganic substances such as graphite, oxides, and glass. They need to conduct heat but are not necessarily insulated. Different shell materials and different inner core materials are selected to achieve at least one selected from the following purposes: (1) The outer layer has high thermal conductivity and insulation, and the inner core has high thermal conductivity and conductivity. After forming the composite powder, the insulation of the shell prevents the electrical conductivity of the inner core. When added to the matrix as a filler, a thermal conductive path is formed between particles, and the dielectric property of the shell blocks the conductive path of the inner core, so that the composite filler can only conduct heat but not electricity. A typical example is h-BN coated graphite. (2) The shell material has high thermal conductivity and insulation, while the inner core material is insulated but has general thermal conductivity, but is low in cost. After forming the composite powder, the inner core plays a role in compatibilization. Under the same volume filling rate, the amount of the shell material is reduced, achieving the purpose of high thermal conductivity and low cost. Typical examples include h-BN coated Al₂O₃ and glass. (3) The physical properties of the thermal conductive material can be significantly improved, the viscosity is reduced, and the hardness is reduced, which is beneficial to the practical application of the thermal conductive material. At the same time, the filling rate can be increased, and the thermal conductivity can be improved. A typical example is h-BN coated graphite. (4) The shell and the inner core of the composite filler may be combined or matched with each other, so that the material can achieve the desired effects in terms of color, thermal expansion coefficient, wettability, corrosion resistance, etc.

For example, the physical integration process of the composite material (h-BN coated graphite) typically includes: mixing the core graphite, shell powder h-BN, and an integrator (e.g., a binder) together, and adhering the shell powder h-BN to the surface of the core graphite through the action of the integrator to form a structure in which the shell powder h-BN coats the surface of the core graphite. However, the inventors have found that for the core-shell structure formed by this physical integration process, when mixed with the matrix material, the obtained material still has high electrical conductivity, and the thermal conductivity is also affected, without compensating for the defect that the core graphite is conductive.

### SUMMARY

Aiming at the shortcomings of the prior art, the embodiments of the present disclosure provide a composite material and a preparation method thereof to improve the defects of a single thermal conductive filler, and the composite material has better aging resistance.

In a first aspect, an embodiment of the present disclosure provides a composite material, including a core and a shell coating the core. The core material has a thermal conductivity of at least 20 W/(m·K), the shell material includes a first metal salt, and the composite material satisfies the following conditions: the composite material has a D50₁ of A, the composite material with a mass of M is placed in a container with a stirring device, stirred for 10 min with a filling ratio of 0.4 and a rotation speed of 500 r/min, then screened through a sieve of (0.1-0.3)×A, and the amount of screen underflow is not higher than 0.05×M.

In the above technical solution, the core material has a thermal conductivity of at least 20 W/(m·K). After the core and the shell are composited, the obtained composite material has a high thermal conductivity, so that the composite material can be used as a thermal conductive filler. At the same time, the metal salt shell can compensate for the defects of the single core material to a certain extent. The composite material is treated under stirring conditions, and the amount of screen underflow is very small, indicating that the shell material and the core material are tightly bonded in the composite material, and the core and the shell are not prone to separation, so that the viscosity of the thermal conductive mixture is lower, the defect compensation effect of the core material is better, and the aging resistance is better.

In a second aspect, an embodiment of the present disclosure provides a composite material, including a core and a shell coating the core. The core material has a thermal conductivity of at least 20 W/(m·K), and the shell material includes a first metal salt obtained by sintering.

In the above technical solution, the core material has a thermal conductivity of at least 20 W/(m·K). After the core and the shell are composited, the obtained composite material has a high thermal conductivity, so that the composite material can be used as a thermal conductive filler. At the same time, the metal salt shell is obtained by sintering. During the sintering process, at least part of the shell material undergoes mass transfer on the surface of the core to obtain a shell material with a better coating effect. The composite material is added to the matrix material as a filler to form a thermal conductive mixture, which can better compensate for the defects of the core material, achieving better aging resistance. Besides, its viscosity in the thermal conductive mixture is lower, so that it can be uniformly dispersed in the thermal conductive mixture, and the defect compensation effect of the core material is better.

In a third aspect, an embodiment of the present disclosure provides a composite material, including a core and a shell coating the core. The shell material includes a first metal salt, the core material has a thermal conductivity of at least 20 W/(m·K), at least one element is common to both the core material and the shell material, and a transition layer is further provided between the core and the shell. The content of at least one element gradually decreases and the content of at least one element gradually increases from outside to inside in the transition layer.

In the above technical solution, the core material has a thermal conductivity of at least 20 W/(m·K). After the core and the shell are composited, the obtained composite material has a high thermal conductivity, so that the composite material can be used as a thermal conductive filler. At the same time, the metal salt shell is obtained by sintering, and during the sintering process, part of the material of the core reacts with the shell raw material to form the shell material, so that at least one element is common to both the core material and the shell material, and a transition layer is further provided between the core and the shell. Since both the core material and the shell raw material participate in the reaction during the sintering process, one element of the transition layer gradually increases and one element gradually decreases. The composite material is added to the matrix material as a filler to form a thermal conductive mixture, which can better compensate for the defects of the core, achieving better aging resistance. Besides, its viscosity in the thermal conductive mixture is lower, so that it can be uniformly dispersed in the thermal conductive mixture, and the defect compensation effect of the core material is better.

In one possible embodiment, the composite material satisfies the following conditions: The composite material has a D50₁ of A, the composite material with a mass of M is placed in a container with a stirring device, stirred for 10 min with a filling ratio of 0.4 and a rotation speed of 500 r/min, then screened through a sieve of (0.1-0.3)×A, and the amount of screen underflow is not higher than 0.02×M.

In the above technical solution, the bonding effect of the two may be further improved, and the obtained composite material is added to the matrix material as a thermal conductive filler to form a thermal conductive mixture, which has lower viscosity and better compensation effect for core defects.

In one possible embodiment, there is no gap between the core and the shell. In the process of adding the composite material to the matrix material to form a thermal conductive mixture, the core and the shell are not prone to separation, so that the viscosity of the thermal conductive mixture is low.

In one possible embodiment, the shell is a complete shell. The shell uniformly coats the surface of the core, and is not prone to falling off under the action of external force.

In one possible embodiment, the shell is a continuous coating layer. The shell uniformly coats the surface of the core, and is not prone to peeling off under the action of external force.

In one possible embodiment, the composite material is free of binder. Thereby, the adverse effect of the binder on the performance of the composite material is avoided. Meanwhile, the bonding performance between the shell and the core is improved.

In one possible embodiment, the shell is not a collection of multiple particles adhered to the surface of the core. If the shell is a collection of multiple particles adhered to the surface of the core, part of the particles of the shell are prone to separation from the core, and when added to the matrix material, they are prone to becoming two independent thermal conductive powders added to the matrix material, ultimately resulting in poor performance of the thermal conductive mixture. However, the shell in the present disclosure is not prone to separation from the core, so that the performance of the thermal conductive mixture is better.

In one possible embodiment, the crystal grains of the core are directly connected to those of the shell. The metal salt shell is obtained by sintering, and during the sintering process, part of the material of the core reacts with the shell raw material to form the shell material, so that the microscopic crystal grains between the shell and the core are directly connected, and the outside of the core is tightly connected to the shell, so that the performance of the inorganic composite filler is better, and after adding it to the matrix material, the performance of the thermal conductive mixture is better.

In one possible embodiment, the shell covers at least 85% of the surface of the core. Most of the surface of the core is covered with the shell material, so that the presence of the shell can mostly compensate for the defects of the core material.

In one possible embodiment, the shell completely covers the core. The surface of the core is completely covered with the shell material, so that the shell can better compensate for the defects of the core material.

In one possible embodiment, the mass fraction of the core is not higher than 95%. At least 5% of the shell may be located on the surface of the core, thereby compensating for part of the defects of the core material.

In one possible embodiment, the mass fraction of the core is 30% to 95%. It can not only make the composite material have a high thermal conductivity due to the presence of the core, but also compensate for the defects of the core material due to the presence of the shell.

In one possible embodiment, the mass fraction of the core is 55% to 80%. It enables the composite material to integrate better properties of the core and the shell, so that the comprehensive performance is improved.

In one possible embodiment, the mass fraction of the core is 60% to 75%.

In one possible embodiment, the core material has a thermal conductivity of 20 W/(m·K) to 500 W/(m·K). Using a material with a higher thermal conductivity as the core can make the thermal conductivity of the final composite material higher.

In one possible embodiment, the core material has a thermal conductivity of 50 W/(m·K) to 250 W/(m·K).

In one possible embodiment, at least one element is common to both the core material and the first metal salt. In the process of sintering to form the shell, the surface layer of the core participates in the reaction to form the shell metal salt, so that at least one element is common to both the core and the first metal salt, thereby achieving better bonding between the core material and the shell material, better adaptability of the material, and better compensation effect for the defects of the core material.

In one possible embodiment, the core is a semiconductor material, and the shell material is an insulating material. After the semiconductor thermal conductive filler is added to the matrix material to form a thermal conductive mixture, the heat dissipation layer formed thereby has poor insulation performance, which has an adverse effect when used in electronic products.

Tightly coating an insulating shell outside the core can compensate for the electrical performance defects of the core semiconductor material through the insulating material, so that the composite material has both higher thermal conductivity and higher breakdown voltage.

In one possible embodiment, the core material is silicon carbide, and the first metal salt is a metal silicate. The metal silicate tightly coats on the surface of silicon carbide. The metal silicate also has certain thermal conductivity and high insulation, so that the composite material has both higher thermal conductivity and breakdown voltage and better insulation performance. Meanwhile, both the shell and the core contain silicon, so that the composite material has better consistency and better thermal conductivity and insulation effects.

In one possible embodiment, the silicon carbide exists as primary particles. Primary particles have fewer interfaces and higher thermal conductivity efficiency, which can make the thermal conductivity performance of the composite material better.

In one possible embodiment, the core material has a Mohs hardness of 7 to 10. After a material with high hardness is added to the matrix material to form a thermal conductive mixture, the heat dissipation layer formed thereby is in contact with the device, which is likely to cause wear on the device. Tightly coating a metal salt material outside the high-hardness core can reduce the hardness of the material, thereby avoiding wear of the thermal conductive filler on the device to a certain extent.

In one possible embodiment, the core material is silicon nitride, and the first metal salt is a metal silicate. Silicon nitride has high hardness and high thermal conductivity. Tightly coating a metal silicate outside silicon nitride can reduce the hardness of the composite material and ensure its thermal conductivity. Meanwhile, both the shell and the core contain silicon, so that the composite material has better consistency, better thermal conductivity, and lower hardness.

In one possible embodiment, the metal silicate includes at least one selected from magnesium silicate, aluminum silicate, zinc silicate, zirconium silicate, magnesium zirconium silicate, aluminum zirconium silicate, and zinc zirconium silicate. The metal silicate may be formed by a chemical reaction between the core (silicon nitride or silicon carbide) and the shell raw material on the surface of the core through sintering, thereby obtaining a composite material with better comprehensive performance, so that when added to the matrix material, the composite material has lower viscosity, higher thermal conductivity, and lower hardness and better insulation performance.

In one possible embodiment, the core material is silicon carbide, the shell material further includes a second metal salt containing at least two metal elements and free of silicon, and the mass fraction of the metal silicate in the shell material is at least 10%. The second metal salt is an insulating material with better thermal conductivity, which can not only ensure that the shell completely covers the core through the metal silicate, but also make the composite material have better thermal conductivity and further improve the insulation performance.

In one possible embodiment, the mass fraction of the metal silicate in the shell material is 20% to 90%.

In one possible embodiment, the second metal salt is aluminate and/or zirconate. It has better thermal conductivity and better insulation performance.

In one possible embodiment, the second metal salt includes at least one selected from zinc aluminate, magnesium aluminate, calcium aluminate, potassium aluminate, zinc zirconate, magnesium zirconate, and calcium aluminate. The shell material containing two metal salts may be formed by sintering, and the second metal salt is the above component, which is composited with the aforementioned metal silicate to make the performance of the composite material better.

In one possible embodiment, the mass fraction of the metal silicate in the shell material is 100%.

In one possible embodiment, the composite material has a D50₁ of 100 μm to 150 μm, the core material is silicon carbide, the shell material is magnesium silicate, and the composite material satisfies the following conditions: 4.8 parts by weight of vinyl silicone oil with a viscosity of 100 mPa·s, 20 parts by weight of the composite material, 21 parts by weight of spherical alumina NSM-1S, 30 parts by weight of spherical alumina BAK-10, and 25 parts by weight of spherical alumina BAK-120 are mixed, first treated for 1 min at a rotation speed of 1100 r/min and a vacuum degree of 1000 Pa; then treated for 1 min at a rotation speed of 1500 r/min and a vacuum degree of 40 Pa; and using an Anton Paar rheometer at 25° C. and shear rates of 0.1 to 100 s⁻¹, a viscosity at 1 s⁻¹ is measured to be 1×10⁶ mPa·s to 1.6×10⁶ mPa·s.

In the above technical solution, the viscosity of the composite material with silicon carbide as the core and magnesium silicate as the shell satisfies the above range, and it has high thermal conductivity and breakdown voltage, and good comprehensive performance.

In one possible embodiment, the core material is silicon carbide, the shell material is a metal silicate, and the composite material satisfies the following conditions: an EDS test is performed on the composite material, and an EDS line scan is conducted from the shell to the core, obtained EDS curves of silicon, oxygen, and metal element are all continuous lines, and in the middle of the curves, content of silicon suddenly increases, while content of oxygen and content of metal element suddenly decrease.

In the above technical solution, the EDS curve of silicon between the core and the shell is unbroken, indicating that there is basically no gap between the core and the shell, and the content of silicon suddenly increases in the middle of the curve, which indirectly proves the difference between the core material and the shell material, and the composite material satisfying this condition has both high thermal conductivity and high breakdown voltage. In other words, the content of silicon in the composition of the core is higher than that in the shell, while the contents of metal element and oxygen in the shell are higher than those in the composition of the core. The content characteristics of these elements are highly consistent with the reaction raw materials and preparation process of the core and the shell.

In one possible embodiment, the core material is silicon carbide the shell material is magnesium silicate, and the composite material satisfies the following conditions: after XPS test on the composite material and subsequent peak deconvolution, a peak-deconvoluted Si2p spectrum includes Si—C bonds with a binding energy of 100 eV to 101 eV and O—Si—O bonds with a binding energy of 105 eV to 106 eV, and a peak-deconvoluted Mgls spectrum includes Mg—O—Si bonds with a binding energy of 1305 eV to 1307 eV.

In one possible embodiment, the core material is silicon carbide, the shell material is zinc silicate, and the composite material satisfies the following conditions: after XPS test on the composite material and subsequent peak deconvolution, a peak-deconvoluted Si2p spectrum includes Si—C bonds with a binding energy of 100 eV to 101 eV and O—Si—O bonds with a binding energy of 105 eV to 106 eV, and a peak-deconvoluted Znls spectrum includes Zn—O—Si bonds with a binding energy of 1022 eV to 1045 eV.

In one possible embodiment, the core material is aluminum nitride, and the shell material includes aluminate. When aluminum nitride is added to a matrix material as a thermal conductive filler to form a thermal conductive mixture, the heat dissipation layer formed thereby is prone to hydrolysis of the thermal conductive filler when used in a high-humidity environment, deteriorating its thermal conductivity. Coating aluminate on the core can avoid hydrolysis of aluminum nitride to a certain extent, achieving higher thermal conductivity and better hydrolysis stability of the composite material. Meanwhile, both the shell and the core contain aluminum. During the sintering process, part of the aluminum nitride participates in the reaction to form aluminate, making the composite material have both better thermal conductivity and hydrolysis stability.

In one possible embodiment, the aluminate includes at least one selected from magnesium aluminate, zinc aluminate, calcium aluminate, potassium aluminate, and aluminum silicate.

The aluminate may be formed by a chemical reaction between the shell raw material on the surface of the core and the core (aluminum nitride) through sintering, thereby obtaining a composite material with better comprehensive performance, which is added to a matrix material to form a thermal conductive mixture with lower viscosity, higher thermal conductivity, and better hydrolysis stability.

In one possible embodiment, the composite material has a D50₁ of at least 0.5 μm. This facilitates the formation of a core-shell structure.

In one possible embodiment, the composite material has a D50₁ of 0.5 μm to 1000 μm. It may be added to a matrix material as a thermal conductive filler to obtain products with higher thermal conductivity.

In one possible embodiment, the composite material has a D50₁ of 0.5 μm to 500 μm. It can be used in combination with most matrix materials.

In one possible embodiment, the composite material has a D50₁ of 0.5 μm to 150 μm, and 0.5≤(D90₁−D10₁)/D50₁≤1.5. The composite material has a reasonable particle size and good uniformity, so that when added to a matrix material as a thermal conductive filler, it is not prone to agglomeration of the thermal conductive filler and can be more uniformly dispersed.

In one possible embodiment, the composite material has a D50₁ of 20 μm to 150 μm, and 0.6≤(D90₁−D10₁)/D50₁≤1.5. It may be used as a coarse powder of thermal conductive filler.

In one possible embodiment, the composite material has a D50₁ of 40 μm to 150 μm, and 0.6≤(D90₁−D10₁)/D50₁≤1.

In one possible embodiment, the composite material has a D50₁ of 0.5 μm to 20 μm, and 0.5≤(D90₁−D10₁)/D50₁≤1. It may be used as a fine powder of thermal conductive filler.

In one possible embodiment, the ratio of the thickness of the shell to the particle size of the composite material is 0.02 to 0.1. The relative thickness of the shell is reasonable, which enables the composite material to have higher thermal conductivity and compensate for the defects of the core material to a certain extent.

In one possible embodiment, the ratio of the thickness of the shell to the particle size of the composite material is 0.04 to 0.07. This further improves the comprehensive performance of the composite material.

In one possible embodiment, the composite material has a tap density of at least 1.85 g/cm³. The composite material has a relatively high tap density, high thermal conductivity, and good compensation for the defects of the core material.

In one possible embodiment, the composite material has a tap density of 1.85 g/cm³ to 2.30 g/cm³.

In one possible embodiment, the composite material has a tap density of 1.90 g/cm³ to 2.30 g/cm³. When the composite material has a tap density within this range, its thermal conductivity is higher and the compensation for the defects of the core material is better.

In one possible embodiment, the composite material has a specific surface area not higher than 4 m²/g. The composite material has a relatively low specific surface area, high thermal conductivity, and good compensation for the defects of the core material.

In one possible embodiment, the composite material has a specific surface area of 0.04 m²/g to 4 m²/g.

In one possible embodiment, the composite material has a D50₁ of 40 μm to 150 μm, and the composite material has a specific surface area of 0.04 m²/g to 0.06 m²/g. The coarse powder has a relatively low specific surface area, a better composite effect between the core and the shell, good material uniformity of the shell, and a complete shell, which enables the composite material to have higher thermal conductivity and better compensation for the defects of the core material.

In a fourth aspect, an embodiment of the present disclosure provides a method for preparing a composite material, including: coating a shell raw material on the surface of a core to form a precursor; sintering the precursor to cause at least part of the shell raw material to undergo mass transfer on the surface of the core to form a shell containing a first metal salt, thereby obtaining the composite material. The core material has a thermal conductivity of at least 20 W/(m·K).

In the above technical solution, during the sintering of the precursor, the shell raw material also undergoes mass transfer on the surface of the core, so that the formed shell containing the metal salt uniformly coats the surface of the core, and there is basically no gap between the shell and the core, so that the composite material obtained after sintering has better performance, thereby better compensating for part of the defects of the core material and having better aging resistance. Meanwhile, the core material has a thermal conductivity of at least 20 W/(m·K), and after the shell is formed by sintering, the composite material obtained has a high thermal conductivity, so that the composite material can be used as a thermal conductive filler.

In one possible embodiment, the core has a tap density of at least 1.90 g/cm³. A higher tap density of the core can result in a better composite effect between the core and the shell, thereby obtaining a composite material with higher thermal conductivity and better compensation for the defects of the core.

In one possible embodiment, the core has a tap density of 1.90 g/cm³ to 2.4 g/cm³. This can obtain a composite material with higher thermal conductivity and better compensation for core defects.

In one possible embodiment, the core material has a thermal conductivity of 20 W/(m·K) to 500 W/(m·K). Using a material with a higher thermal conductivity as the core can make the thermal conductivity of the final composite material higher.

In one possible embodiment, the core material has a thermal conductivity of 50 W/(m·K) to 250 W/(m·K).

In one possible embodiment, the shell raw material has a D50₂ of 0.05 μm to 10 μm, the core material has a D50₃ of 0.5 μm to 1000 μm, and 0.00001≤D50₂/D50₃≤0.1. The shell raw material with a relatively small particle size is easy to coat the surface of the core material, so as to form a uniformly coated core-shell structure after subsequent sintering.

In one possible embodiment, the core material has a D50₃ of 0.5 μm to 500 μm, and 0.0001≤D50₂/D50₃≤0.1. Matching the core material and the shell material that satisfy this condition can result in a better coating effect of the precursor, thereby obtaining a more uniform shell and improving the comprehensive performance of the composite material.

In one possible embodiment, the core material has a D50₃ of 0.5 μm to 140 μm, and 0.0003≤D50₂/D50₃≤0.1. Matching the core material and the shell material that satisfy the condition can make the obtained composite material more easily added to a matrix material as a thermal conductive filler, facilitating its application in the field of thermal conductivity.

In one possible embodiment, the mass fraction of the shell raw material in the precursor is 1% to 30%. This can form a better shell after sintering and, to a certain extent, avoid the adverse effect of an excessively thick shell on thermal conductivity.

In one possible embodiment, the mass fraction of the shell raw material in the precursor is 5% to 20%. This enables the shell to completely coat the core and avoids an excessively thick shell, so that the composite material has better thermal conductivity and can better compensate for the defects of the core material.

In one possible embodiment, the core material is silicon nitride or silicon carbide, and the shell raw material includes at least one selected from elemental magnesium, magnesium oxide, magnesium hydroxide, organic magnesium, elemental zinc, zinc oxide, zinc hydroxide, organic zinc, elemental zirconium, zirconium oxide, zirconium hydroxide, and organic zirconium, and during sintering, at least part of the shell raw material reacts with the core and undergoes mass transfer to form a shell containing a first metal salt.

In the above technical solution, the chemical reaction between the core material and the shell raw material allows SiO generated by the core to be transferred to the outer layer to react with the shell raw material to form a silicate, such as magnesium silicate, aluminum silicate, zinc silicate, zirconium silicate, magnesium zirconium silicate, aluminum zirconium silicate, zinc zirconium silicate, etc., thereby in-situ forming a metal silicate shell on the surface of the core, so that the composite material has better thermal conductivity and better insulation performance (for composites with silicon carbide as the core) or reduced hardness (for composites with silicon nitride as the core).

In one possible embodiment, the shell raw material includes at least one selected from elemental magnesium, magnesium oxide, magnesium hydroxide, elemental aluminum, aluminum oxide, aluminum hydroxide, elemental zinc, zinc oxide, zinc hydroxide, elemental zirconium, zirconium oxide, and zirconium hydroxide. The above shell raw material is easily available and readily react with silicon nitride or silicon carbide under sintering conditions to obtain the shell material.

In one possible embodiment, the shell raw material includes at least one selected from magnesium oxide, aluminum oxide, zinc oxide, and zirconium oxide. The metal oxides are used as the shell material, which makes it easy to react with silicon nitride or silicon carbide to obtain metal silicate. If two metal oxides are used as shell raw material, a shell material including a second metal salt in addition to the metal silicate can be formed, thereby obtaining a shell with multiple materials and making the composite material have better performance.

In one possible embodiment, the sintering is performed at a temperature of 1000° C. to 1400° C. for 3 h to 8 h.

In one possible embodiment, the sintering is performed at a temperature of 1300° C. to 1400° C. for 3 h to 8 h.

In one possible embodiment, the core material is silicon carbide, and the silicon carbide exists as primary particles. Primary particles have fewer interfaces and higher thermal conductivity efficiency, which can make the thermal conductivity performance of the composite material better.

In one possible embodiment, the core material is aluminum nitride, and the shell raw material includes at least one selected from zinc oxide, magnesium oxide, calcium oxide, potassium oxide, and silicon oxide, and during sintering, at least part of the shell raw material reacts with the core and undergoes mass transfer to form a shell containing a first metal salt.

In the above technical solution, the surface of the core may chemically react with the shell raw material through sintering, so that AlO generated by the core is transferred to the outer layer to react with the shell raw material to form aluminate, and the shell material may include at least one selected from magnesium aluminate, zinc aluminate, calcium aluminate, potassium aluminate, and aluminum silicate.

In one possible embodiment, the sintering is performed at a temperature of 1400° C. to 1800° C. for 3 h to 8 h.

In one possible embodiment, the shell raw material includes hydrated silicate, and during sintering, at least part of the hydrated silicate melts and undergoes mass transfer on the surface of the core to form a shell containing a silicate.

In the above technical solution, during the sintering process, the shell raw material melts into a flowable state, so that the molten shell raw material can undergo mass transfer on the surface of the core, and the hydrated silicate are converted into a silicate, and a composite material with better coating effect can be obtained, which can better compensate for the defects of the core material and has better comprehensive performance.

In one possible embodiment, the hydrated silicate includes one or more of hydrated magnesium silicate, hydrated sodium silicate, hydrated sodium aluminosilicate, and hydrated calcium aluminosilicate.

In one possible embodiment, the sintering is performed at a temperature higher than a melting point of at least part of the hydrated silicate for 3 h to 8 h.

In one possible embodiment, the method for forming the precursor includes: mixing the core, shell raw material and a coating aid, and then performing coating. By mixing and coating in conjunction with a coating aid, the shell raw material can be uniformly adhered to the surface of the core, and during the sintering process, the shell raw material undergoes mass transfer, finally forming a relatively complete coating shell that more uniformly coats the surface of the core.

In one possible embodiment, the core material is silicon nitride or silicon carbide, and the coating aid is a coating aid containing silicon. The coating aid containing silicon allows the shell raw material to react with both the core material and the coating aid, thereby obtaining a product with more uniform coating, better coating effect, and reduced agglomeration tendency, and the composite material has better thermal conductivity.

In one possible embodiment, the coating aid includes tetraethyl orthosilicate. Tetraethyl orthosilicate can be used as a coating aid on the one hand and can provide silicon on the other hand, allowing the shell raw material to react with both the core material and tetraethyl orthosilicate, and finally forming the shell material.

In one possible embodiment, the mass fraction of the coating aid in the precursor is 1% to 15%. This can achieve a better coating effect while avoiding the adverse effect of excessive use of the coating aid on the performance of the composite material.

In one possible embodiment, the mass fraction of the coating aid in the precursor is 3% to 10%.

In one possible embodiment, the coating is performed by wet ball milling at a rotation speed of 200 r/min to 600 r/min for at least 1 h. Coating by means of wet ball milling may be performed in conjunction with a coating aid to make the shell raw material more uniformly coat the surface of the core and avoid agglomeration of the core during the coating process.

In one possible embodiment, the rotation speed of the wet ball milling is 300 r/min to 500 r/min, and the duration of the wet ball milling is 1 h to 6 h.

### BRIEF DESCRIPTION OF DRAWINGS

To more clearly illustrate the technical solutions in the embodiments of the present disclosure, the accompanying drawings required for describing the embodiments are briefly introduced below. It should be understood that the drawings show only exemplary embodiments of the present disclosure and are non-limiting, and for a person of ordinary skill in the art, other embodiments derived from these drawings without inventive effort shall fall within the scope of the present disclosure.

FIG. 1 is a schematic structural diagram of a composite material provided in an embodiment of the present disclosure;

FIG. 2 is a process flow diagram of a method for preparing a composite material provided in an embodiment of the present disclosure;

FIG. 3 is an SEM image of a precursor in Example R1 of the present disclosure (magnified 200 times);

FIG. 4 is an SEM image of a composite material in Example R1 of the present disclosure (magnified 200 times);

FIG. 5 is an SEM image of a precursor in Example R21 of the present disclosure (magnified 500 times);

FIG. 6 is an SEM image of a composite material in Example R21 of the present disclosure (magnified 500 times);

FIG. 7 is an SEM image of a composite material in Example R28 of the present disclosure (magnified 2000 times);

FIG. 8 is an SEM image of a composite material in Example R33 of the present disclosure (magnified 2000 times);

FIG. 9 is an XRD pattern of the precursor in Example R1 of the present disclosure;

FIG. 10 is an XRD pattern of the composite material in Example R1 of the present disclosure;

FIG. 11 is an XRD pattern of the precursor in Example R21 of the present disclosure;

FIG. 12 is an XRD pattern of the composite material in Example R21 of the present disclosure;

FIG. 13 is a peak-deconvoluted XPS Si2p spectrum analysis diagram of the precursor in Example R1 of the present disclosure;

FIG. 14 is a peak-deconvoluted XPS Si2p spectrum analysis diagram of the composite material in Example R1 of the present disclosure;

FIG. 15 is a peak-deconvoluted XPS Mg1s spectrum analysis diagram of the precursor in Example R1 of the present disclosure;

FIG. 16 is a peak-deconvoluted XPS Mg1s spectrum analysis diagram of the composite material in Example R1 of the present disclosure;

FIG. 17 is a peak-deconvoluted XPS Si2p spectrum analysis diagram of the precursor in Example R21 of the present disclosure;

FIG. 18 is a peak-deconvoluted XPS Si2p spectrum analysis diagram of the composite material in Example R21 of the present disclosure;

FIG. 19 is a peak-deconvoluted XPS Mg1s spectrum analysis diagram of the precursor in Example R21 of the present disclosure;

FIG. 20 is a peak-deconvoluted XPS Mg1s spectrum analysis diagram of the composite material in Example R21 of the present disclosure;

FIG. 21 shows the EDS line-scan direction of the precursor in Example R21 of the present disclosure;

FIG. 22 is an EDS line-scan profile of the precursor in Example R21 of the present disclosure;

FIG. 23 is a carbon-specific EDS line-scan profile of the precursor in Example R21 of the present disclosure;

FIG. 24 is a silicon-specific EDS line-scan profile of the precursor in Example R21 of the present disclosure;

FIG. 25 shows the EDS line-scan direction of the composite material in Example R21 of the present disclosure;

FIG. 26 is an EDS line-scan profile of the composite material in Example R21 of the present disclosure;

FIG. 27 is a carbon-specific EDS line-scan profile of the composite material in Example R21 of the present disclosure;

FIG. 28 is a silicon-specific EDS line-scan profile of the composite material in Example R21 of the present disclosure;

FIG. 29 is an oxygen-specific EDS line-scan profile of the composite material in Example R21 of the present disclosure;

FIG. 30 is a zinc-specific EDS line-scan profile of the composite material in Example R21 of the present disclosure;

FIG. 31 is an SEM cross-section image of the composite material in Example R1 of the present disclosure (magnified 6400 times);

FIG. 32 is an SEM cross-section image of the composite material in Example R21 of the present disclosure (magnified 6400 times); and

FIG. 33 is an SEM cross-section image of the composite material in Example R1 of the present disclosure (magnified 60,000 times).

Reference signs: 100—composite material; 110—core; 120—shell.

### DETAILED DESCRIPTION OF EMBODIMENTS

The inventors have found that for a thermal conductive filler with a core-shell structure formed by physical integration, such as a core-shell thermal conductive filler with silicon carbide as the core and magnesium silicate as the shell, after being added to vinyl silicone oil to form a silicone mixture and cured to form a layered structure, its thermal conductivity is greatly reduced, and the breakdown voltage is basically not improved (compared with the layered structure formed by curing a silicone mixture formed by adding silicon carbide alone to vinyl silicone oil).

The inventors studied the cause of this problem and found that the thermal conductive filler with a core-shell structure (silicon carbide core and magnesium silicate shell) formed by physical integration being added to vinyl silicone oil eventually results in poor thermal conductivity and insulation performance of the silicone layer formed after curing the silicone mixture.

Therefore, the inventors intended to develop a method for forming a shell through in-situ reaction, so that when the composite material is added to silicone oil to form a silicone mixture, the silicone layer formed after curing the silicone mixture can have both better thermal conductivity and better insulation performance. The inventors first sintered silicon carbide in an air atmosphere at 1300° C. for 2 h, so that the surface layer of the silicon carbide shell reacted with oxygen to obtain silicon dioxide, thereby obtaining a theoretically silicon dioxide-coated silicon carbide composite thermal conductive filler. The inventors added it to vinyl silicone oil, uniformly mixed the thermal conductive filler with vinyl silicone oil to form a silicone mixture, then cured it to form a silicone layer, and tested its thermal conductivity and breakdown voltage. It was found that the thermal conductivity was greatly reduced, and the breakdown voltage was not significantly improved (compared with the layered structure formed by curing a silicone mixture formed by adding silicon carbide alone to vinyl silicone oil).

The inventors continued to study and found that sintering silicon carbide in a high-temperature aerobic environment causes the surface of silicon carbide particles to be oxidized and corroded, damaging the structure of the particles themselves. The reason is that silicon carbide particles are obtained by crushing, and their surfaces are uneven. When in contact with air, the reaction rate of oxygen with the protruding positions on the surface is greater than that with the concave positions on the surface, which leads to the formation of silicon dioxide particulates on the protruding surface of silicon carbide instead of a well-coating shell on the surface of silicon carbide, ultimately leading to poor performance of the composite thermal conductive filler.

Based on the above, the inventors have developed a new composite material with a core-shell structure, in which the shell can compensate for the defects of the core to a certain extent.

When the composite material is added to a matrix material as a thermal conductive filler, the thermal conductive mixture forms a layered structure with better thermal conductivity after curing, and the defects of the core are compensated, and the aging resistance is also better.

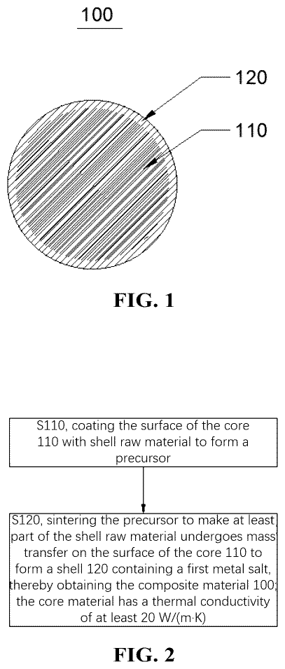

Composite Material FIG. 1 is a schematic structural diagram of a composite material 100 provided in an embodiment of the present disclosure. Referring to FIG. 1, the composite material 100 includes a core 110 and a shell 120 coating the core 110, the core material has a thermal conductivity of at least 20 W/(m·K), the shell material includes a first metal salt, and the composite material 100 satisfies the following conditions: the composite material 100 has a D50₁ of A, the composite material 100 with a mass of M is placed in a container with a stirring device, stirred for 10 min with a filling ratio of 0.4 and a rotation speed of 500 r/min, and then screened through a sieve of (0.1-0.3)×A, and the amount of screen underflow is not higher than 0.05×M.

The composite material 100 has a particulate structure, and the shape of the composite material 100 may be particles with high sphericity as shown in FIG. 1, or particles with low sphericity, or special-shaped particles, etc., which is not limited in the present disclosure. The core 110 of the composite material 100 refers to the core 110 of the particulate. The shell 120 of the composite material 100 refers to the shell 120 of the particulate. As can be seen from FIG. 1, there is no obvious gap between the core 110 and the shell 120, and the materials of the core 110 (the core 110 is a single material or a composite material) are different from those of the shell 120 (the shell 120 is a single material or a composite material).

The thermal conductivity of the core material: the principle of measuring the thermal properties of materials by the transient plane heat source method is based on the transient temperature response generated by a step-heated disc-shaped heat source in an infinite medium. A planar probe is made of a thermal resistive material and used as both a heat source and a temperature sensor. The thermal resistance coefficient of nickel: the relationship between temperature and resistance is linear, that is, the heat loss can be known by understanding the change in resistance, thereby reflecting the thermal conductivity of the sample. The Hotdisk probe is a thin sheet with a continuous double-helix structure formed by etching conductive metal nickel, with a double-layer polyimide (Kapton) protective layer on the outer layer, with a thickness of only 0.025 mm, which gives the probe a certain mechanical strength and maintains electrical insulation from the sample. During the test, the probe is placed in the middle for testing. When an electric current passes through nickel, a certain temperature rise is generated, and the heat generated diffuses to the samples on both sides of the probe at the same time, and the rate of thermal diffusion depends on the thermal conduction characteristics of the material. By recording the temperature and the response time of the probe, the thermal conductivity and thermal diffusivity can be directly obtained from the mathematical model, and the volumetric heat capacity can be obtained from the ratio of the two. At the initial test, a small temperature drop occurs on the Kapton coating, and after a short time, the temperature drop remains constant because the output power is constant.

The resistance change of the probe can be expressed by the following formula.

$$R ( t ) = R o [ 1 + αΔ Ti + αΔ T ( τ ) ] \qquad ( 1 )$$

where
Rₒ: resistance of the probe before instantaneous recording;
α: temperature coefficient of resistance (TCR);
ΔTᵢ: temperature difference in the thin film protective layer (since the protective layer is very thin, ΔTᵢ can be regarded as a constant value in a short time); and
ΔT(τ): average temperature rise of the probe when in ideal perfect contact with the sample.
ΔT(τ) can be expressed as:

$$Δ T ( τ ) = QD ( τ ) / ( λ {r}_{0} π \hat{} 3 / 2 ) \qquad ( 2 )$$

where
Q: constant output power;
rₒ: probe radius;
λ: thermal conductivity of the tested sample, i.e., the value we require; and
D(τ): dimensionless time function.

Assuming R*=Rₒ(1+αΔTᵢ), K=αRₒQ/(λrₒπ\hat{ }3/2), substituting equation (2) into equation (1) gives:

$$R ( t ) = {R}^{*} + KD ( τ ) \qquad ( 3 )$$

Plotting the measured resistance value R(t) against D(τ) gives a straight line with an intercept of C. By repeatedly transforming the characteristic time θ for fitting, the linear correlation of R(t) to D(τ) is maximized, and the thermal conductivity can then be calculated from the slope K of the straight line.

A filling ratio of 0.4 means that the volume of the container is V mL, the volume of the composite material 100 is V₁ mL, and V₁/V=0.4. For example, if the volume of the container is 500 mL and the volume of the composite material 100 is 200 mL, the filling ratio of the container is 0.4. The volume of the composite material 100 refers to the bulk volume of the composite material 100.

After the composite material 100 is stirred, it is screened through a sieve of (0.1-0.3)×A. The sieve size may be selected by first calculating a range value (0.1×A to 0.3×A) based on the A value (D50₁ value) of the composite material 100×(0.1-0.3), then selecting one sieve specification within this range for screening, and then detecting the content of the screen underflow.

Exemplarily, the composite material 100 has a D50₁ of A, the composite material 100 with a mass of M is placed in a container with a stirring device, stirred for 10 min with a filling ratio of 0.4 and a rotation speed of 500 r/min, and then screened through a sieve of (0.1-0.3)×A, and the amount of screen underflow is 0.05×M, 0.04×M, 0.03×M, 0.02×M, 0.01×M, or 0.

In the composite material 100 of the present disclosure, the core material has a thermal conductivity of at least 20 W/(m·K), and after the core 110 and the shell 120 are composited, the composite material 100 has a high thermal conductivity, so that the composite material 100 can be used as a thermal conductive filler. At the same time, the metal salt shell can compensate for the defects of the single core material to a certain extent. The composite material 100 is treated under stirring conditions, and the amount of screen underflow is very small, indicating that the shell material and the core material are tightly bonded in the composite material 100, and the core 110 and the shell 120 are not prone to separation, so that the viscosity of the thermal conductive mixture is lower, the defect compensation effect of the core material is better, and the aging resistance is also better.

An embodiment of the present disclosure further provides a composite material 100, including a core 110 and a shell 120 coating the core 110. The core material has a thermal conductivity of at least 20 W/(m·K), and the shell material includes a first metal salt obtained by sintering.

The shell raw material reacts during sintering to obtain the first metal salt, which may be used as at least part of the shell material, so that there is no gap between the shell 120 and the core 110, and mass transfer of the shell raw material occurs during sintering, so that the formed shell 120 uniformly coats the surface of the core 110.

In the composite material 100 of the present disclosure, the core material has a thermal conductivity of at least 20 W/(m·K), and after the core 110 and the shell 120 are composited, the composite material 100 has a high thermal conductivity, so that the composite material 100 can be used as a thermal conductive filler. Meanwhile, the metal salt shell is obtained by sintering. During the sintering process, at least part of the shell material undergoes mass transfer on the surface of the core 110 to obtain a shell material with a better coating effect. The composite material 100, when added to a matrix material as a filler, forms a thermal conductive mixture, which can better compensate for the defects of the core material, achieving better aging resistance, and a lower viscosity in the thermal conductive mixture for uniform dispersion in the thermal conductive mixture.

An embodiment of the present disclosure further provides a composite material 100, including a core 110 and a shell 120 coating the core 110. The shell material includes a first metal salt, the core material has a thermal conductivity of at least 20 W/(m·K), at least one element is common to both the core material and the shell material, and a transition layer (which is a micro-structure, not shown in the figure) is further provided between the core 110 and the shell 120, the content of at least one element gradually decreases and the content of at least one element gradually increases from outside to inside in the transition layer.

The transition layer refers to a layer structure in which the elements of the material gradually change. For example, the core material is a material with relatively uniform element content (which may be a single material or a composite material), the shell material is also a material with relatively uniform element content (which may be a single material or a composite material), and the material in the transition layer is not a single material, but may be a material with gradually changing element content.

In the above technical solution, the core material has a thermal conductivity of at least 20 W/(m·K), and after the core 110 is combined with the shell 120, the composite material 100 obtained has a high thermal conductivity, so that the composite material 100 can be used as a thermal conductive filler. Meanwhile, the metal salt shell is obtained by sintering, and during the sintering process, part of the material of the core 110 reacts with the shell raw material to form the shell material, so that at least one element is common to both the core material and the shell material, and a transition layer is further provided between the core 110 and the shell 120. Since both the core material and the shell raw material participate in the reaction during the sintering process, one element of the transition layer gradually increases and one element gradually decreases, so that the composite material 100, when added to a matrix material as a filler, forms a thermal conductive mixture that can better compensate for the defects of the core, achieving better aging resistance. Besides, its viscosity in the thermal conductive mixture is lower, so that it can be uniformly dispersed in the thermal conductive mixture, and the defect compensation effect of the core material is better.

In the present disclosure, the composite material may be used as a thermal conductive filler, a ceramic material, or other insulating materials, or a filler in some usable materials, etc., which is not limited in the present disclosure.

In one embodiment, the mass fraction of the core 110 is not higher than 95%. The mass fraction of the core 110 is analyzed by the RIR method after XRD detection: the basic principle is that there is a ratio of the integrated intensity of the strongest diffraction peak of the shell material to that of the core material, and this ratio is the RIR value. By calculating the integral strength/RIR value of the shell material, the integral strength of the core material can be converted. For a mixture, all components in the substance are converted by this method, and finally the percentage content of a specific component can be obtained by the normalization method.

The core material has a thermal conductivity typically higher than that of the shell material, and at least 5% of the shell 120 in the composite material 100 is located on the surface of the core 110, thereby compensating for part of the defects s of the core material.

By way of example only, the mass fraction of the core 110 is 20%, 25%, 30%, 35%, 40%, 45%, 50%, 55%, 60%, 65%, 70%, 75%, 80%, 85%, 90% or 95%. Optionally, the mass fraction of the core 110 is 30% to 95%. The composite material 100 can have a high thermal conductivity due to the presence of the core 110, and meanwhile, the defects of the core material can be compensated by the presence of the shell 120.

In one embodiment, the mass fraction of the core 110 is 55% to 80%. The composite material 100 can have a higher thermal conductivity, and the shell material with this content can provide a wider coating surface for the surface of the core 110, basically achieving complete coating of the surface of the core 110, which can better compensate for the defects of the core material, so that the composite material 100 can integrate better properties of the core 110 and the shell 120, making its comprehensive performance better. Optionally, the mass fraction of the core 110 is 60% to 75%, which can make the comprehensive performance of the composite material 100 better.

In one embodiment, the core material has a thermal conductivity of 20 W/(m·K) to 500 W/(m·K). The core material has a thermal conductivity of an inherent property of the material. Using a material with higher thermal conductivity as the core 110 can make the thermal conductivity of the final composite material 100 higher.

By way of example only, the core material has a thermal conductivity of 20 W/(m·K), 50 W/(m·K), 100 W/(m·K), 150 W/(m·K), 200 W/(m·K), 250 W/(m·K), 300 W/(m·K), 350 W/(m·K), 400 W/(m·K), 450 W/(m·K) or 500 W/(m·K). Optionally, the core material has a thermal conductivity of 50 W/(m·K) to 250 W/(m·K).

In one embodiment, at least one element is common to both the core material and the first metal salt. After the composite material is stirred, the amount of screen underflow is very small, or one element is common to both the sintered first metal salt and the core material, which can make the bonding between the core material and the shell material better, and meanwhile, the material has better adaptability, and the compensation effect for the defects of the core material is better.

### First Kind of Composite Materials

In the present disclosure, the core 110 may be various inorganic thermal conductive fillers. In one embodiment, the core 110 is a semiconductor material. If the semiconductor material is used as a thermal conductive filler in electronic products, the performance of the electronic products may be affected due to the semiconductor properties of the thermal conductive filler (for example, the composite material 100 may be used as a thermal conductive filler for thermal conductive gaskets or thermal conductive gels, and can be applied to 5G, electronics industry, new energy fields, etc.). Therefore, the semiconductor thermal conductive filler has the defect of poor insulation performance to a certain extent.

In the present disclosure, the surface of the semiconductor core is coated with an insulating shell, the shell material is an insulating material and includes a first metal salt, and the insulating metal salt shell can compensate for the defects of the semiconductor core material to a certain extent. When the composite material is treated under stirring conditions, the amount of screen underflow is very small, indicating that the shell material and the core material are tightly bonded in the composite material, and the core and the shell are not prone to separation, which can make the viscosity of the thermal conductive mixture lower, and meanwhile, the thermal conductivity and insulation performance are better, and the aging resistance is also better.

Optionally, the core material may be silicon carbide or aluminum oxide. If the core material is silicon carbide, the first metal salt in the shell material is a metal silicate, and if the core material is aluminum oxide, the first metal salt in the shell material is an aluminate.

The following takes the core material being silicon carbide and the shell material including metal silicate as an example for description. The thermal conductivity of silicon carbide is 80 W/(m·K) to 490 W/(m·K). In one embodiment, there is no gap between the core 110 and the shell 120, that is, there is no gap between the silicon carbide core and the shell 120 containing metal silicate, and the metal silicate coats the surface of silicon carbide without gaps, which can make the composite material 100 have both higher thermal conductivity and higher breakdown voltage and better insulation performance.

In one embodiment, the shell 120 is a complete shell, and the shell 120 containing metal silicate coated outside the silicon carbide core is a complete shell. The complete shell and the complete coating are two concepts. The complete shell means that the connected area between the shells 120 is an integrated structure, which coats the surface of the core 110. The shell 120 uniformly coats the surface of the core 110, and the shell 120 of the composite material 100 is not prone to falling off under the action of an external force, and can make the composite material 100 have higher thermal conductivity and better insulation performance.

In one embodiment, the shell 120 is a continuous coating layer, and the shell 120 containing metal silicate coated outside the silicon carbide core is a continuous coating layer. The continuous coating layer and the complete coating are also two concepts. The continuous coating layer means that the connection position of the coating layer is an integrated connection rather than a discontinuous or layered structure, and the shell 120 of the composite material 100 is not prone to peeling off under the action of an external force, and can make the composite material 100 have higher thermal conductivity and better insulation performance. The complete coating means that the surface of silicon carbide is completely coated with a metal silicate shell, and no surface of silicon carbide is exposed.

In one embodiment, the composite material 100 is free of binder. The composite material 100 of the present disclosure is obtained by reaction after sintering a silicon carbide core coated with a shell 120 containing metal silicate at high temperature. The composite material 100 obtained by the reaction after sintering is free of binder (the binder is typically an organic substance that cannot withstand high temperature and will react at high temperature and no longer exist in the form of a binder). The bonding between silicon carbide and metal silicate in the composite material 100 is good, and the adverse effect of the binder on the performance of the composite material 100 can be avoided to a certain extent.

In one embodiment, the shell 120 is not a collection of multiple metal silicate particles adhered to the surface of the core 110. The existing physical coating method (adding a binder to coat the shell 120 on the surface of the core 110) makes the shell 120 a collection of multiple particles adhered to the surface of the core 110. Some particles of the shell 120 are prone to separation from the core 110. When added to the matrix material, they are prone to becoming independent silicon nitride powder and metal silicate powder to be added to the matrix material, finally resulting in poor performance of the thermal conductive mixture.

However, at least part of the shell material in the present disclosure is obtained by chemical reaction through sintering, which is not a collection of multiple particles physically adhered to the surface of the core 110, and the shell 120 is not prone to separation from the core 110, which can make the performance of the thermal conductive mixture better.

In one embodiment, the crystal grains of the core 110 are directly connected to the crystal grains of the shell 120. The metal silicate shell is obtained by sintering, and in the sintering process, the silicon carbide on the surface reacts with the shell raw material to form metal silicate, so that the microscopic crystal grains between the shell 120 and the core 110 are directly connected, and the outside of the silicon carbide core is tightly connected to the shell 120, thereby the performance of the inorganic composite filler is better, and after adding it to the matrix material, the performance of the thermal conductive mixture is better.

In one embodiment, the composite material 100 satisfies the following conditions: the composite material 100 has a D50₁ of A, the composite material 100 with a mass of M is placed in a container with a stirring device, stirred for 10 min with a filling ratio of 0.4 and a rotation speed of 500 r/min, and then screened through a (0.1-0.3)×A sieve, and the amount of screen underflow is not higher than 0.02×M. The silicon carbide core and the shell 120 containing metal silicate are tightly connected, and the obtained composite filler has both higher thermal conductivity and higher breakdown voltage.

In one embodiment, the silicon carbide core exists as primary particles. The primary particle means that the silicon carbide particles are not obtained by agglomeration, but are silicon carbide particles obtained by crushing a large piece of silicon carbide or directly formed, and the silicon carbide particles basically contain no pores. The silicon carbide primary particle core 110 has a high thermal conductivity. After being composited with the shell 120, the formed composite material 100 also has a high thermal conductivity, so that it can be added to the matrix material as a thermal conductive filler. At the same time, the silicon carbide core exists as primary particles, which have fewer interfaces and higher thermal conductivity, so that it is easy to make the composite material 100 have better thermal conductivity.

In one embodiment, the shell 120 containing metal silicate covers at least 85% of the surface of the silicon carbide core. Most of the surface of the silicon carbide core is covered with a shell material containing metal silicate, so that the presence of the shell 120 can make the insulation performance of the composite material 100 better, so that the composite material 100 can be applied to the field of electronic products and improve the service performance of electronic products.

In one embodiment, the shell 120 completely covers the core 110. The surface of the silicon carbide core is completely covered with the shell 120 (the shell 120 containing metal silicate), that is, the entire surface of the core 110 is covered with a complete shell or the entire surface of the core 110 is covered with a continuous coating layer (shell 120). After the composite material 100 is added as a thermal conductive filler to the matrix material to form a thermal conductive mixture, the formed layer structure has a higher breakdown voltage and better insulation performance, and meanwhile, its thermal conductivity is basically not affected.

In the present disclosure, the core material of the composite material 100 is silicon carbide, and the metal salt of the shell material includes metal silicate, which includes at least one selected from magnesium silicate, aluminum silicate, zinc silicate, zirconium silicate, magnesium zirconium silicate, aluminum zirconium silicate and zinc zirconium silicate. The metal silicate may be formed by chemical reaction between the shell raw material on the surface of silicon carbide and silicon carbide through sintering, thereby obtaining a material with better insulation and thermal conductivity. Then it is added to the matrix material as a thermal conductive filler to achieve lower viscosity, higher thermal conductivity, and the advantage of higher breakdown voltage.

In one embodiment, the metal salt of the shell material includes a metal silicate (first metal salt) and a second metal salt containing at least two metal elements and free of silicon, and the mass fraction of the metal silicate in the shell material is at least 10%. The second metal salt contains two metal elements and has better thermal conductivity (compared with the metal silicate), which can make the shell 120 completely cover the core 110 through the metal silicate, and at the same time, make the composite material 100 have better thermal conductivity. Meanwhile, the second metal salt also has certain insulation, which can make the composite material 100 have better insulation performance.

By way of example only, for the composite material 100 with the core 110 being silicon carbide, the mass fraction of metal silicate in the shell material is 10%, 15%, 20%, 25%, 30%, 35%, 40%, 45%, 50%, 55%, 60%, 65%, 70%, 75%, 80%, 85% or 90%. Optionally, the mass fraction of metal silicate in the shell material is 20% to 90%.

Further, the mass fraction of metal silicate in the shell material is 40% to 80%. The high content of metal silicate can make the bonding between the core 110 and the shell 120 better. Meanwhile, the performance of the shell material is also better, and the bonding performance of the two materials in the shell 120 is also better, so that the comprehensive performance of the composite material 100 is better.

In the present disclosure, the core 110 is a composite material of silicon carbide 100, the first metal salt of the shell material is metal silicate, and the second metal salt is aluminate or/and zirconate. It has better thermal conductivity and better insulation performance. Optionally, the second metal salt includes at least one selected from zinc aluminate, magnesium aluminate, calcium aluminate, potassium aluminate, zinc zirconate, magnesium zirconate, calcium aluminate and potassium aluminate. The second metal salt can be well bonded with the first metal salt, and the thermal conductivity and the insulation performance of aluminate or/and zirconate are better than those of metal silicate, so that the composite material 100 has both better thermal conductivity and insulation performance.

In another embodiment, the metal salts of the shell material are all metal silicates, and the mass fraction of the metal silicates in the shell material is 100%. In the composite material 100 with the core 110 being silicon carbide, all the shell material is metal silicate, which has high purity and is convenient to prepare.

In another embodiment, the shell material may also contain some metal oxides (shell raw material that has not reacted with the core material), which is not limited in the present disclosure, as long as some of the shell raw material reacts with the core material to obtain metal silicate.

In some embodiments, the composite material has a D50₁ of 100 μm to 150 μm, the core material is silicon carbide, the shell material is magnesium silicate, and the composite material 100 satisfies the following conditions: 4.8 parts by weight of vinyl silicone oil with a viscosity of 100 mPa·s, 20 parts by weight of the composite material 100, 21 parts by weight of spherical alumina NSM-1S, 30 parts by weight of spherical alumina BAK-10 and 25 parts by weight of spherical alumina BAK-120 are mixed, first treated for 1 min with a rotation speed of 1100 r/min and a vacuum degree of 1000 Pa; then treated for 1 min with a rotation speed of 1500 r/min and a vacuum degree of 40 Pa; and using an Anton Paar rheometer at 25° C. and shear rates of 0.1 to 100 s⁻¹, the viscosity at 1 s⁻¹ is measured to be 1×10⁶ mPa·s to 1.6×10⁶ mPa·s.

The viscosity of the composite material 100 satisfies the above range, and it has both higher thermal conductivity and higher breakdown voltage, and better comprehensive performance.

By way of example only, the above viscosity values are 1×10⁶ mPa·s, 1.1×10⁶ mPa·s, 1.2×10⁶ mPa·s, 1.3×10⁶ mPa·s, 1.4×10⁶ mPa·s, 1.5×10⁶ mPa·s or 1.6×10⁶ mPa·s.

In some embodiments, for the composite material 100 with the core 110 being silicon carbide, the ratio of the thickness of the shell 120 to the particle size of the composite material 100 is 0.02 to 0.1. The relative thickness of the shell 120 containing metal silicate is reasonable, which can make the composite material 100 have high thermal conductivity and improve the insulation performance of the composite material 100. In the present disclosure, the thickness of different regions of the shell 120 may be different, as long as the ratio of the thickness of some regions to the particle size of the composite material 100 is within the range of 0.02 to 0.1.

By way of example only, the ratio of the thickness of the shell 120 containing metal silicate to the particle size of the composite material 100 is 0.02, 0.03, 0.04, 0.05, 0.06, 0.07, 0.08, 0.09 or 0.1. Optionally, the ratio of the thickness of the shell 120 containing metal silicate to the particle size of the composite material 100 is 0.04 to 0.07. This further improves the thermal conductivity and insulation performance of the composite material 100.

### Second Kind of Composite Materials

In the present disclosure, the core 110 may also be various high-hardness materials. In one embodiment, the core material has a Mohs hardness of 7 to 10. If the high-hardness core material is added to the matrix material as a thermal conductive filler to form a thermal conductive mixture, and the thermal conductive mixture is cured to form a thermal conductive medium layer arranged between other devices, the high-hardness thermal conductive filler in the thermal conductive medium layer may cause wear on the device during the long-term use of the devices, thereby affecting the service life of the devices. Therefore, in the present disclosure, the surface of the core 110 with a Mohs hardness of 7 to 10 is tightly coated with a shell material containing a metal salt, and the metal salt shell has the Mohs hardness of lower than 7, so that the composite material 100 has better thermal conductivity and lower hardness. At the same time, when the composite material is treated under stirring conditions, the amount of screen underflow is very small, indicating that the shell material and the core material are tightly bonded in the composite material, and the core and the shell are not prone to separation. As a thermal conductive filler, it is added to the matrix material to form a thermal conductive mixture, which can make the viscosity of the thermal conductive mixture lower. After forming the thermal conductive medium layer, it has higher thermal conductivity and low hardness, which can make the device have better wear resistance and better aging resistance.

Optionally, the core material may be silicon carbide (with a Mohs hardness of 9.5), silicon nitride (with a Mohs hardness of 9 to 9.5) or aluminum oxide (with a Mohs hardness of 9). If the core material is silicon nitride, the first metal salt in the shell material is metal silicate, and if the core material is aluminum oxide, the first metal salt in the shell material is aluminate.

The following takes the core material being silicon nitride and the shell material including metal silicate as an example for description. The silicon nitride has a thermal conductivity of 40 W/(m·K) to 320 W/(m·K). In one embodiment, there is no gap between the core 110 and the shell 120, that is, there is no gap between the silicon nitride core and the shell 120 containing metal silicate, and the metal silicate coats the surface of silicon nitride without gaps, which can make the composite material 100 have higher thermal conductivity and lower hardness, so as to avoid wear on the contacted devices caused by it as a thermal conductive filler.

In one embodiment, the shell 120 is a complete shell, and the shell 120 containing metal silicate coated outside the silicon nitride core is a complete shell. The complete shell and the complete coating are two concepts. The complete shell means that the connected area between the shells 120 is an integrated structure, which coats the surface of the core 110. The shell 120 uniformly coats the surface of the core 110, and the shell 120 of the composite material 100 is not prone to falling off under the action of an external force, and can make the composite material 100 have higher thermal conductivity and lower surface hardness, further improving the wear resistance of the device. The complete coating means that the surface of silicon nitride is completely coated with a metal silicate shell, and no surface of silicon nitride is exposed.

In one embodiment, the shell 120 is a continuous coating layer, and the shell 120 containing metal silicate coated outside the silicon nitride core is a continuous coating layer. The continuous coating layer and the complete coating are also two concepts. The continuous coating layer means that the connection position of the coating layer is an integrated connection rather than a discontinuous or layered structure, and the shell 120 of the composite material 100 is not prone to peeling off under the action of an external force, and can make the composite material 100 have higher thermal conductivity and, to a certain extent, avoid the wear of the thermal conductive medium layer formed by it as a thermal conductive filler on the device.

In one embodiment, the composite material 100 is free of binder. The composite material 100 of the present disclosure is obtained by reaction after sintering a silicon nitride core coated with a shell 120 containing metal silicate at high temperature. The composite material 100 obtained by the reaction after sintering is free of binder (the binder is typically an organic substance that cannot withstand high temperature and will react at high temperature and no longer exist in the form of a binder). The bonding between silicon nitride and metal silicate in the composite material 100 is good, and the adverse effect of the binder on the performance of the composite material 100 can be avoided to a certain extent.

In one embodiment, the shell 120 is not a collection of multiple metal silicate particles adhered to the surface of the core 110. The existing physical coating method (adding a binder to coat the shell 120 on the surface of the core 110) makes the shell 120 a collection of multiple metal silicate particles adhered to the surface of the silicon nitride core. Some particles of the shell 120 are prone to separation from the core 110. When added to the matrix material, they are prone to becoming independent silicon carbide powder and metal silicate powder to be added to the matrix material, finally resulting in poor performance of the thermal conductive mixture. However, at least part of the shell 120 in the present disclosure is obtained by chemical reaction through sintering, which is not a collection of multiple particles physically adhered to the surface of the core 110, and the shell 120 is not prone to separation from the core 110, which can make the performance of the thermal conductive mixture better.

In one embodiment, the crystal grains of the core 110 are directly connected to the crystal grains of the shell 120. The metal silicate is obtained by sintering, and in the sintering process, the silicon nitride on the surface reacts with the shell raw material to form metal silicate, so that the microscopic crystal grains between the shell 120 and the core 110 are directly connected, and the outside of the silicon nitride core is tightly connected to the shell 120, thereby the performance of the inorganic composite filler is better, and after adding it to the matrix material, the performance of the thermal conductive mixture is better.

In one embodiment, the composite material 100 satisfies the following conditions: the composite material 100 has a D50₁ of A, the composite material 100 with a mass of M is placed in a container with a stirring device, stirred for 10 min with a filling ratio of 0.4 and a rotation speed of 500 r/min, and then screened through a (0.1˜0.3)×A sieve, and the amount of screen underflow is not higher than 0.02×M. The silicon nitride core and the shell 120 containing metal silicate are tightly connected, and the obtained composite filler has high thermal conductivity and low strength, and is not prone to causing wear on the device.

In one embodiment, the shell 120 containing metal silicate covers at least 85% of the surface of the silicon nitride core. Most of the surface of the silicon nitride core is covered with a shell material containing metal silicate, so that the presence of the shell 120 can reduce the hardness of the composite material 100, so that the wear of the thermal conductive medium layer containing the composite material 100 on the device is reduced or eliminated, and the thermal conductivity of the thermal conductive medium layer is also better.

In one embodiment, the shell 120 completely covers the core 110. The surface of the silicon nitride core is completely covered with the shell 120 (the shell 120 containing metal silicate), that is, the entire surface of the core 110 is covered with a complete shell or the entire surface of the core 110 is covered with a continuous coating layer (shell 120). After the composite material 100 is added as a thermal conductive filler to the matrix material to form a thermal conductive mixture, the formed layer structure has lower hardness and less wear on the device, and meanwhile, its thermal conductivity is basically not affected.

In the present disclosure, the core material is silicon nitride, and the shell material includes metal silicate, which includes at least one selected from magnesium silicate, aluminum silicate, zinc silicate, zirconium silicate, magnesium zirconium silicate, aluminum zirconium silicate and zinc zirconium silicate. The metal silicate may be formed by chemical reaction between the shell raw material on the surface of silicon nitride and silicon nitride through sintering, thereby obtaining a material with lower hardness and better thermal conductivity. Then it is added to the matrix material as a thermal conductive filler to achieve lower viscosity, higher thermal conductivity, and the reduction of wear on the device.

By way of example only, for the composite material 100 with the core 110 being silicon nitride, the mass fraction of metal silicate in the shell material is 10%, 15%, 20%, 25%, 30%, 35%, 40%, 45%, 50%, 55%, 60%, 65%, 70%, 75%, 80%, 85% or 90%. Optionally, the mass fraction of metal silicate in the shell material is 20% to 90%.

Further, the mass fraction of metal silicate in the shell material is 40% to 80%. The other components in the shell material may also be metal oxides. The higher content of metal silicate can make the bonding between the core 110 and the shell 120 better. Meanwhile, the performance of the shell material is also better, and the bonding performance of the two materials in the shell 120 is also better, so that the comprehensive performance of the composite material 100 is better.

In another embodiment, the metal salts of the shell material are all metal silicates, and the mass fraction of the metal silicates in the shell material is 100%. In the composite material 100 with the core 110 being silicon carbide, all the shell material is metal silicate, which has high purity and is convenient to prepare.

In another embodiment, the shell material may also contain some metal oxides (shell raw material that has not reacted with the core material), which is not limited in the present disclosure, as long as some of the shell raw material reacts with the core material to obtain metal silicate.

In some embodiments, for the composite material 100 with the core 110 being silicon nitride, the ratio of the thickness of the shell 120 to the particle size of the composite material 100 is 0.02 to 0.1. The relative thickness of the shell 120 containing metal silicate is reasonable, which can make the composite material 100 have higher thermal conductivity and avoid wear on the device. In the present disclosure, the thickness of different regions of the shell 120 may be different, as long as the ratio of the thickness of some regions to the particle size of the composite material 100 is within the range of 0.02 to 0.1.

By way of example only, the ratio of the thickness of the shell 120 containing metal silicate to the particle size of the composite material 100 is 0.02, 0.03, 0.04, 0.05, 0.06, 0.07, 0.08, 0.09 or 0.1. Optionally, the ratio of the thickness of the shell 120 containing metal silicate to the particle size of the composite material 100 is 0.04 to 0.07. This further improves the thermal conductivity of the composite material 100 and avoids wear on the device.

### Third Kind of Composite Materials

In the present disclosure, the core 110 may also be various hydrolysable thermal conductive fillers. In one embodiment, the core 110 is a hydrolysable material. If it is used as a thermal conductive filler to form a thermal conductive medium layer, the thermal conductive filler in the thermal conductive medium layer may be hydrolyzed after long-term use in a high-humidity environment, resulting in a decrease in the thermal conductivity of the thermal conductive medium layer. In the present disclosure, the surface of the hydrolysable core 110 is tightly coated with a water-insoluble shell 120. The water-insoluble shell material includes a first metal salt, and the metal salt shell has better hydrolysis stability, so that the composite material also has better hydrolysis stability. At the same time, when the composite material is treated under stirring conditions, the amount of screen underflow is very small, indicating that the shell material and the core material are tightly bonded in the composite material, and the core and the shell are not prone to separation, which can make the viscosity of the thermal conductive mixture low, and meanwhile, the thermal conductivity and hydrolysis stability are better, and the aging resistance is also better, so that high thermal conductivity can be maintained for a long time.

Optionally, the core material is aluminum nitride, and the shell material includes aluminate. The aluminum nitride has a thermal conductivity of 80 W/(m·K) to 320 W/(m·K). In one embodiment, there is no gap between the core 110 and the shell 120, that is, there is no gap between the aluminum nitride core and the shell 120 containing aluminate, and the aluminate coats the surface of aluminum nitride without gaps, which can make the composite material 100 have higher thermal conductivity and better hydrolysis stability.

In one embodiment, the shell 120 is a complete shell, and the shell 120 containing aluminate coated outside the aluminum nitride core is a complete shell. The complete shell and the complete coating are two concepts. The complete shell means that the connected area between the shells 120 is an integrated structure, which coats the surface of the core 110. The shell 120 uniformly coats the surface of the core 110, and the shell 120 of the composite material 100 is not prone to falling off under the action of an external force, and can make the composite material 100 have higher thermal conductivity and better hydrolysis stability. The complete coating means that the surface of aluminum nitride is completely coated with an aluminate shell, and no surface of aluminum nitride is exposed.

In one embodiment, the shell 120 is a continuous coating layer, and the shell 120 containing aluminate coated outside the aluminum nitride core is a continuous coating layer. The continuous coating layer and the complete coating are also two concepts. The continuous coating layer means that the connection position of the coating layer is an integrated connection rather than a discontinuous or layered structure, and the shell 120 of the composite material 100 is not prone to peeling off under the action of an external force, and can make the composite material 100 have higher thermal conductivity and better hydrolysis stability.

In one embodiment, the composite material 100 is free of binder. The composite material 100 of the present disclosure is obtained by reaction after sintering an aluminum nitride core coated with a shell 120 containing aluminate at high temperature. The composite material 100 obtained by the reaction after sintering is free of binder (the binder is typically an organic substance that cannot withstand high temperature and will react at high temperature and no longer exist in the form of a binder). The bonding between aluminum nitride and aluminate in the composite material 100 is good, and the adverse effect of the binder on the performance of the composite material 100 can be avoided to a certain extent.

In one embodiment, the shell 120 is not a collection of multiple aluminate particles adhered to the surface of the core 110. The existing physical coating method (adding a binder to coat the shell 120 on the surface of the core 110) makes the shell 120 a collection of multiple aluminate particles adhered to the surface of the aluminum nitride core. Some particles of the shell 120 are prone to separation from the core 110. When added to the matrix material, they are prone to becoming independent silicon carbide powder and metal silicate powder to be added to the matrix material, finally resulting in poor performance of the thermal conductive mixture. However, at least part of the shell 120 in the present disclosure is obtained by chemical reaction through sintering, which is not a collection of multiple particles physically adhered to the surface of the core 110, and the shell 120 is not prone to separation from the core 110, which can make the performance of the thermal conductive mixture better.

In one embodiment, the crystal grains of the core 110 are directly connected to the crystal grains of the shell 120. The aluminate is obtained by sintering, and in the sintering process, the aluminum nitride on the surface reacts with the shell raw material to form aluminate, so that the microscopic crystal grains between the shell 120 and the core 110 are directly connected, and the outside of the aluminum nitride core is tightly connected to the shell 120, thereby the performance of the inorganic composite filler is better, and after adding it to the matrix material, the performance of the thermal conductive mixture is better.

In one embodiment, the composite material 100 satisfies the following conditions: the composite material 100 has a D50₁ of A, the composite material 100 with a mass of M is placed in a container with a stirring device, stirred for 10 min with a filling ratio of 0.4 and a rotation speed of 500 r/min, and then screened through a (0.1-0.3)×A sieve, and the amount of screen underflow is not higher than 0.02×M. The aluminum nitride core and the shell 120 containing aluminate are tightly connected, and the obtained composite filler has both high thermal conductivity and better hydrolysis stability.

In one embodiment, the shell 120 containing aluminate covers at least 85% of the surface of the aluminum nitride core. Most of the surface of the aluminum nitride core is covered with a shell material containing aluminate, so that the presence of the shell 120 can make the hydrolysis stability of the composite material 100 better, so that the service life of the composite material 100 in a high-humidity environment is longer.

In one embodiment, the shell 120 completely covers the core 110. The surface of the aluminum nitride core is completely covered with a shell material (the shell 120 containing aluminate). After the composite material 100 is added to the matrix material as a thermal conductive filler to form a thermal conductive mixture, the formed layer structure has better hydrolysis stability, and meanwhile, its thermal conductivity is basically not affected.

In the present disclosure, the core material is aluminum nitride, and the shell material includes aluminate, which includes at least one selected from magnesium aluminate, zinc aluminate, calcium aluminate, potassium aluminate and aluminum silicate. The aluminate may be formed by chemical reaction between the shell raw material on the surface of aluminum nitride and aluminum nitride through sintering, thereby obtaining a material with better hydrolysis stability and thermal conductivity. Then it is added to the matrix material as a thermal conductive filler to achieve lower viscosity, higher thermal conductivity, and longer service life in a high-humidity environment.

In another embodiment, the shell material includes aluminate and shell raw material (for example, at least one selected from magnesium oxide, zinc oxide, calcium oxide, potassium oxide and silicon oxide), which is not limited in the present disclosure, as long as some of the shell raw material reacts with the core material to obtain aluminate.

In some embodiments, for the composite material 100 with the core 110 being aluminum nitride, and the ratio of the thickness of the shell 120 to the particle size of the composite material 100 is 0.02 to 0.1. The relative thickness of the shell 120 containing aluminate is reasonable, which can make the composite material 100 have higher thermal conductivity and good hydrolysis stability. In the present disclosure, the thickness of different regions of the shell 120 may be different, as long as the ratio of the thickness of some regions to the particle size of the composite material 100 is within the range of 0.02 to 0.1.

By way of example only, the ratio of the thickness of the shell 120 containing aluminate to the particle size of the composite material 100 is 0.02, 0.03, 0.04, 0.05, 0.06, 0.07, 0.08, 0.09 or 0.1. Optionally, the ratio of the thickness of the aluminate-containing shell 120 to the particle size of the composite material 100 is 0.04 to 0.07. The thermal conductivity of the composite material 100 is further improved, and the hydrolysis stability is better.

In some embodiments, the composite material has a tap density not lower than 1.85 g/cm³. The composite material 100 has a relatively high tap density, high thermal conductivity, and a more regular shape.

By way of example only, the tap density of the composite material 100 are 1.85 g/cm³, 1.90 g/cm³, 1.95 g/cm³, 2.00 g/cm³, 2.05 g/cm³, 2.10 g/cm³, 2.15 g/cm³, 2.20 g/cm³, 2.25 g/cm³, 2.30 g/cm³, or 2.35 g/cm³. Optionally, the tap density of the composite material 100 is 1.85 g/cm³ to 2.30 g/cm³. Further, the tap density of the composite material 100 is 1.90 g/cm³ to 2.30 g/cm³. When the tap density of the composite material 100 is within this range, its thermal conductivity is higher and its comprehensive performance is better.

In some embodiments, the specific surface area of the composite material 100 is not higher than 4 m²/g. The composite material 100 has a relatively low specific surface area, high thermal conductivity, and a better composite effect of the shell material on the surface of the core.

By way of example only, the specific surface area of the composite material 100 is 0.01 m²/g, 0.1 m²/g, 0.2 m²/g, 0.4 m²/g, 0.6 m²/g, 1 m²/g, 2 m²/g, 3 m²/g, or 4 m²/g. Optionally, the specific surface area of the composite material 100 is 0.04 m²/g to 4 m²/g.

In some embodiments, the composite material 100 has a D50₁ of at least 0.5 μm. This facilitates the formation of a core-shell structure. By way of example only, the composite material 100 has a D50₁ of 0.5 μm, 1 μm, 5 μm, 10 μm, 20 μm, 50 μm, 100 μm, 200 μm, 400 μm, 800 μm, or 1200 μm. Optionally, the composite material 100 has a D50₁ of 0.5 μm to 1000 μm. The composite material 100 satisfying this particle size can be added to the matrix material as a thermal conductive filler to obtain a product with higher thermal conductivity.

Further, the composite material 100 has a D50₁ of 0.5 μm to 500 μm. It can be used in combination with most matrix materials. the composite material 100 has a D50₁ of 0.5 μm to 150 μm, and 0.5≤(D90₁−D10₁)/D50₁≤1.5. The particle size of the composite material 100 is reasonable, and its uniformity is better, so that after being added to the matrix material as a thermal conductive filler, the thermal conductive filler is not prone to agglomeration and can be more uniformly dispersed.

In some embodiments, the composite material 100 has a D50₁ of 20 μm to 150 μm, and 0.6≤(D90₁−D10₁)/D50₁≤1.5. It may be used as a coarse powder of thermal conductive filler. Optionally, the composite material 100 has a D50₁ of 40 μm to 150 μm, 0.6≤(D90₁−D10₁)/D50₁≤1, and the specific surface area of the composite material 100 is 0.04 m²/g to 0.06 m²/g.

In other embodiments, the composite material 100 has a D50₁ of 0.5 μm to 20 μm, and 0.5≤(D90₁−D10₁)/D50₁≤1. It can be used as fine powder for a thermal conductive filler.

### Method for Preparing Composite Material

After the composite material 100 is introduced above, the method for preparing the composite material 100 will be specifically described below. FIG. 2 is a process flow chart of the preparation of the composite material provided in an embodiment of the present disclosure. Referring to FIG. 2, the method includes: S110, coating the surface of the core 110 with shell raw material to form a precursor; S120, sintering the precursor to make at least part of the shell raw material undergoes mass transfer on the surface of the core 110 to form a shell 120 containing a first metal salt, thereby obtaining the composite material 100. The core material has a thermal conductivity of at least 20 W/(m·K).

If the core 110 is directly sintered in an aerobic environment without coating, a coating structure with the shell 120 and the core 110 cannot be formed, but multiple protruding oxide particles are formed on the surface of the core 110. However, in the present disclosure, the shell raw material are first coated to form a precursor, and during the sintering of the precursor, the shell raw material also undergo mass transfer on the surface of the core 110, so that the formed shell 120 containing a metal salt uniformly coats the surface of the core 110, and there is basically no gap between the shell 120 and the core 110, so that the composite material 100 obtained after sintering has better performance, so as to better compensate for part of the defects of the core material, achieving better aging resistance. At the same time, the core material has a thermal conductivity of at least 20 W/(m·K), and after the shell 120 is formed by sintering, the obtained composite material 100 has a high thermal conductivity, so that the composite material 100 can be used as a thermal conductive filler.

The mass transfer means that after the shell raw material coats the surface of the core 110, the positions of the shell raw material or the reacted materials on the surface of the core 110 will have slight movement during the sintering process, so that the coating of the obtained shell 120 can be more uniform.

In one embodiment, the core material has a thermal conductivity of 20 W/(m·K) to 500 W/(m·K). The core material has a thermal conductivity of an inherent property of the material. Using a material with higher thermal conductivity as the core 110 can make the thermal conductivity of the final composite material 100 higher, so that it can be used as a thermal conductive filler.

By way of example only, the core material has a thermal conductivity of 20 W/(m·K), 50 W/(m·K), 100 W/(m·K), 150 W/(m·K), 200 W/(m·K), 250 W/(m·K), 300 W/(m·K), 350 W/(m·K), 400 W/(m·K), 450 W/(m·K) or 500 W/(m·K). Optionally, the core material has a thermal conductivity of 50 W/(m·K) to 250 W/(m·K).

In some embodiments, the sintering is performed at a temperature of 900° C. to 1800° C. for 1 h to 10 h. Sintering under this condition can basically make the core material and the shell raw material react, thereby obtaining the core-shell composite material 100 with a metal salt shell.

In some embodiments, the sintering atmosphere may be an air atmosphere, a nitrogen atmosphere, an inert gas atmosphere, etc., which is not limited in the present disclosure.

### Method for Preparing the First Kind of Composite Materials

The method includes: coating the surface of the semiconductor core with shell raw material to form a precursor; sintering the precursor to make at least part of the shell raw material undergoes mass transfer on the surface of the core 110 to form a shell 120 containing a first metal salt, thereby obtaining the composite material 100. The core material has a thermal conductivity of at least 20 W/(m·K). The following takes the core 110 being silicon carbide as an example for description.

The method for preparing the composite material 100 with the core 110 being silicon carbide includes: coating the surface of the silicon carbide core with shell raw material to form a precursor, and sintering the precursor to make at least part of the shell raw material undergoes mass transfer on the surface of the silicon carbide core to form a shell 120 containing a first metal silicate, thereby obtaining the composite material 100.

In this preparation method, the shell raw material may be roughly coated first, and then the shell raw material are subjected to mass transfer on the surface layer of silicon carbide in the subsequent sintering process, so that a relatively uniform and complete shell 120 can be formed on the surface of the silicon carbide core, so as to satisfy the thermal conductivity of the composite material 100, improve the breakdown voltage of the composite material 100, and make its insulation performance better, so as to be applied in the field of electronic products.

In some embodiments, the silicon carbide core exists as primary particles. The primary particle has few interfaces and high thermal conductivity efficiency, which can make the thermal conductivity performance of the composite material 100 better.

In some embodiments, the tap density of the silicon carbide core is not lower than 1.90 g/cm³. The higher tap density of the core 110 can make the composite effect of the core 110 and the shell 120 better, thereby obtaining the composite material 100 with higher thermal conductivity and better insulation performance.

By way of example only, the tap density of the silicon carbide core is 1.90 g/cm³, 1.95 g/cm³, 2.00 g/cm³, 2.05 g/cm³, 2.10 g/cm³, 2.15 g/cm³, 2.20 g/cm³, 2.25 g/cm³, 2.30 g/cm³, 2.35 g/cm³, 2.40 g/cm³, or 2.45 g/cm³. Optionally, the tap density of the silicon carbide core is 1.90 g/cm³ to 2.4 g/cm³. The composite material 100 with higher thermal conductivity and better insulation performance can be obtained.

In some embodiments, the core material is silicon carbide, and the shell raw material includes at least one selected from elemental magnesium, magnesium oxide, magnesium hydroxide, organic magnesium, elemental zinc, zinc oxide, zinc hydroxide, organic zinc, elemental zirconium, zirconium oxide, zirconium hydroxide, and organic zirconium, and during sintering, at least part of the shell raw material reacts with the core 110 and undergo mass transfer to form the shell 120 containing the first metal salt. During sintering, the shell raw material are caused to undergo mass transfer on the surface of silicon carbide while reacting with the surface layer of silicon carbide, thereby obtaining magnesium silicate, aluminum silicate, zinc silicate, zirconium silicate, magnesium zirconium silicate, aluminum zirconium silicate, zinc zirconium silicate, etc., thereby in-situ forming a shell containing metal silicate on the surface of the core 110, so that the composite material 100 has better thermal conductivity and better insulation performance.

Optionally, the shell raw material includes at least one selected from elemental magnesium, magnesium oxide, magnesium hydroxide, elemental aluminum, aluminum oxide, aluminum hydroxide, elemental zinc, zinc oxide, zinc hydroxide, elemental zirconium, zirconium oxide, and zirconium hydroxide. The above-mentioned shell raw material is easily available and easily react with silicon carbide under the sintering condition, thereby obtaining the shell material.

Further, the shell raw material includes at least one selected from magnesium oxide, aluminum oxide, zinc oxide, and zirconium oxide. The metal oxides are used as the shell material, which makes it easy to react with silicon carbide to obtain a metal silicate. If two metal oxides are used as the shell raw material, a shell material including a second metal salt in addition to the metal silicate can be formed, thereby obtaining a shell 120 with multiple materials, so that the performance of the composite material 100 is better.

In some embodiments, the core material is silicon carbide, and the sintering is performed at a temperature of 1000° C. to 1400° C. for 3 h to 8 h. Under this condition, silicon carbide can chemically react with elemental magnesium, magnesium oxide, magnesium hydroxide, organic magnesium, elemental zinc, zinc oxide, zinc hydroxide, organic zinc, elemental zirconium, zirconium oxide, zirconium hydroxide, organic zirconium and other substances to obtain magnesium silicate, aluminum silicate, zinc silicate, zirconium silicate, magnesium zirconium silicate, aluminum zirconium silicate, zinc zirconium silicate, etc.

By way of example only, the sintering temperature is 1000° C., 1050° C., 1100° C., 1150° C., 1200° C., 1250° C., 1300° C., 1350° C., or 1400° C., and the sintering time is 3 h, 4 h, 5 h, 6 h, 7 h, or 8 h. Optionally, the core material is silicon carbide, and the sintering is performed at a temperature of 1300° C. to 1400° C. for 3 h to 8 h.

In another embodiment, the core material is silicon carbide, and the shell raw material is hydrated silicate. During sintering, at least part of the hydrated silicate melts and undergoes mass transfer on the surface of the core 110 to form a silicate-containing shell 120. During sintering, the shell raw material melts to undergo mass transfer on the surface of the silicon carbide core, and water is separated, so that a silicate shell 120 can be obtained, and the composite material 100 has better thermal conductivity and better insulation performance.

Optionally, the hydrated silicate includes one or more of hydrated magnesium silicate, hydrated sodium silicate, hydrated sodium aluminosilicate, and hydrated calcium aluminosilicate. The shell material obtained after sintering includes magnesium silicate, sodium silicate, sodium aluminosilicate, calcium aluminosilicate, etc.

Optionally, the sintering is performed at a temperature higher than a melting point of at least part of the hydrated silicate for 3 h to 8 h. For example, when the shell raw material is hydrated magnesium silicate (talcum powder), the sintering is performed at 850° C. to 1000° C. for 3 h to 8 h.

In some embodiments, D50₂ of the shell raw material is 0.05 μm to 10 μm, D50₃ of the silicon carbide core is 0.5 μm to 1000 μm, and 0.00001≤D50₂/D50₃≤0.1. The shell raw material with relatively small particle sizes is easy to coat on the surface of the silicon carbide core, so as to form a uniformly coated core-shell structure after subsequent sintering.

By way of example only, D50₂ of the shell raw material is 0.05 μm, 0.1 μm, 0.15 μm, 0.3 μm, 0.5 μm, 0.7 μm, 0.9 μm, 1.1 μm, 1.3 μm, 1.5 μm, 1.7 μm, 1.9 μm, 2 μm, 3 μm, 4 μm, 5 μm, 6 μm, 7 μm, 8 μm, 9 μm, or 10 μm; D50₃ of the silicon carbide core is 0.5 μm, 1 μm, 5 μm, 10 μm, 20 μm, 50 μm, 100 μm, 200 μm, 400 μm, 800 μm, or 1000 μm, and the value of D50₂/D50₃ is 0.00001, 0.00005, 0.0001, 0.0005, 0.001, 0.005, 0.01, 0.05, or 0.1.

In the present disclosure, D50₃ of the silicon carbide core is 0.5 μm to 1000 μm, and the composite material 100 has a D50₁ of 0.5 μm to 1000 μm. It does not mean that the particle size of the composite material 100 obtained after coating and sintering the core 110 is consistent with the particle size of the core 110. Generally, the particle size of the composite material 100 obtained after coating and sintering is slightly larger than that of the core 110, and the corresponding details are not given here.

Optionally, D50₃ of the silicon carbide core is 0.5 μm to 500 μm, and 0.0001≤D50₂/D50₃≤0.1. Matching the core material and the shell material that satisfy this condition can make the coating effect of the precursor better, thereby obtaining a more uniform shell 120 subsequently, and improving the thermal conductivity and insulation performance of the composite material 100.

Further, D50₃ of the silicon carbide core is 0.5 μm to 140 μm, and 0.0003≤D50₂/D50₃≤0.1.

Matching the silicon carbide core and the shell material that satisfy the condition can make the obtained composite material 100 more easily added to the matrix material as a thermal conductive filler, so as to facilitate its application in the field of thermal conductivity.

In some embodiments, the mass fraction of the shell raw material in the precursor is 1% to 30%. It is possible to form a better shell 120 after sintering and, to a certain extent, avoid the adverse effect of the excessive thickness of the shell 120 on the thermal conductivity.

By way of example only, the mass fraction of the shell raw material in the precursor is 1%, 3%, 5%, 8%, 10%, 15%, 20%, 25%, or 30%. Optionally, the mass fraction of the shell raw material in the precursor is 5% to 20%. The shell 120 can completely coat the core 110 and avoid the excessive thickness of the shell 120, so that the composite material 100 has better thermal conductivity and higher insulation performance.

In some embodiments, the method for forming the precursor includes: mixing the silicon carbide core, the shell raw material, and a coating aid, and then performing coating. By mixing and coating in conjunction with the coating aid, the shell raw material can be uniformly adhered to the surface of the silicon carbide core, and during the sintering process, the shell raw material will undergo mass transfer, and finally a relatively complete coating shell 120 is formed, and the shell 120 more uniformly coats the surface of the silicon carbide core.

Optionally, the coating aid includes a coating aid containing a silicon, which can make the shell raw material react with silicon carbide and also react with the coating aid, thereby obtaining a product with more uniform coating, better coating effect, and reduced agglomeration tendency, and the composite material has a higher dielectric constant and higher thermal conductivity.

Optionally, the coating aid includes tetraethyl orthosilicate. Tetraethyl orthosilicate can be used as a coating aid on the one hand and can further provide silicon on the other hand, so that the shell raw material can react with the silicon carbide core and can also react with tetraethyl orthosilicate, and finally a product with more uniform coating, better coating effect, and reduced agglomeration tendency is obtained, and the composite material 100 also has a higher thermal conductivity. Further, the coating aid is tetraethyl orthosilicate.

In other embodiments, the coating aid may also be polyvinyl butyral resin, acrylic resin, etc., which is not limited in the present disclosure, and any coating aid that can make the shell raw material better adhere to the surface of the silicon carbide core shall fall within the protection scope of the present disclosure.

In some embodiments, the mass fraction of the coating aid in the precursor is 1% to 15%. The coating effect can be better, and the performance of the composite material 100 can be prevented from being affected by excessive use of the coating aid.

By way of example only, the mass fraction of the coating aid in the precursor is 1%, 2%, 4%, 6%, 9%, 12%, or 15%. Optionally, the mass fraction of the coating aid in the precursor is 3% to 10%. The coating effect can be better, and excessive use of the coating aid can be avoided, so that more shell raw material can react with the silicon carbide core.

In some embodiments, the coating is performed by wet ball milling at a rotation speed of 200 r/min to 600 r/min for at least 1 h. Coating by means of wet ball milling may be performed in conjunction with the coating aid to make the shell raw material more uniformly coat the surface of the core 110, and avoid the agglomeration of the core 110 in the coating process of the raw material.

By way of example only, the rotation speed of the wet ball milling is 200 r/min, 250 r/min, 300 r/min, 350 r/min, 400 r/min, 450 r/min, 500 r/min, 550 r/min, or 600 r/min, and the duration of the wet ball milling is 1 h, 2 h, 3 h, 4 h, 5 h, 6 h, 7 h, 8 h, 9 h, or 10 h. Optionally, the rotation speed of the wet ball milling is 300 r/min to 500 r/min, and the duration of the wet ball milling is 1 h to 6 h.

### Method for Preparing the Second Kind of Composite Materials

The method includes: coating the surface of the core 110 (with a Mohs hardness of 7 to 10) with shell raw material to form a precursor; and sintering the precursor to make at least part of the shell raw material undergoes mass transfer on the surface of the core 110 to form a shell 120 containing a first metal salt, thereby obtaining the composite material 100. The core material has a thermal conductivity of at least 20 W/(m·K). The following takes the core 110 being silicon nitride as an example for description.

The method for preparing the composite material 100 with the core 110 being silicon nitride includes: coating the surface of the silicon nitride core with shell raw material to form a precursor, and sintering the precursor to make at least part of the shell raw material undergoes mass transfer on the surface of the silicon nitride core to form a shell 120 containing a first metal silicate, thereby obtaining the composite material 100.

In this preparation method, the shell raw material may be roughly coated first, and then the shell raw material are subjected to mass transfer on the surface layer of silicon nitride in the subsequent sintering process, so that a relatively uniform and complete shell 120 can be formed on the surface of the silicon nitride core, so as to satisfy the thermal conductivity of the composite material 100 and reduce its hardness, so as to reduce the wear on the device when it is used as a thermal conductive filler subsequently.

In some embodiments, the tap density of the silicon nitride core is not lower than 1.90 g/cm³. The higher tap density of the core 110 can make the composite effect of the core 110 and the shell 120 better, thereby obtaining the composite material 100 with higher thermal conductivity and lower hardness.

By way of example only, the tap density of the silicon nitride core is 1.90 g/cm³, 1.95 g/cm³, 2.00 g/cm³, 2.05 g/cm³, 2.10 g/cm³, 2.15 g/cm³, 2.20 g/cm³, 2.25 g/cm³, 2.30 g/cm³, 2.35 g/cm³, 2.40 g/cm³, or 2.45 g/cm³. Optionally, the tap density of the silicon nitride core is 1.90 g/cm³ to 2.4 g/cm³. The composite material 100 with higher thermal conductivity and lower hardness can be obtained.

In some embodiments, the core material is silicon nitride, and the shell raw material includes at least one selected from elemental magnesium, magnesium oxide, magnesium hydroxide, organic magnesium, elemental zinc, zinc oxide, zinc hydroxide, organic zinc, elemental zirconium, zirconium oxide, zirconium hydroxide, and organic zirconium, and during sintering, at least part of the shell raw material reacts with the core 110 and undergo mass transfer to form the shell 120 containing the first metal salt. During sintering, the shell raw material are caused to undergo mass transfer on the surface of silicon carbide while reacting with the surface layer of silicon nitride, thereby obtaining magnesium silicate, aluminum silicate, zinc silicate, zirconium silicate, magnesium zirconium silicate, aluminum zirconium silicate, zinc zirconium silicate, etc., thereby in-situ forming a shell containing metal silicate on the surface of the silicon nitride core, so that the composite material 100 has better thermal conductivity and lower hardness.

Optionally, the shell raw material includes at least one selected from elemental magnesium, magnesium oxide, magnesium hydroxide, elemental aluminum, aluminum oxide, aluminum hydroxide, elemental zinc, zinc oxide, zinc hydroxide, elemental zirconium, zirconium oxide, and zirconium hydroxide. The above-mentioned shell raw material is easily available and easily react with silicon nitride under the sintering condition, thereby obtaining the shell material.

Further, the shell raw material includes at least one selected from magnesium oxide, aluminum oxide, zinc oxide, and zirconium oxide. The metal oxides are used as the shell material, which makes it easy to react with silicon nitride to obtain a metal silicate. If two metal oxides are used as the shell raw material, a shell material including a second metal salt in addition to the metal silicate can be formed, thereby obtaining a shell 120 with multiple materials, so that the performance of the composite material 100 is better.

In some embodiments, the core material is silicon nitride, and the sintering is performed at a temperature of 1000° C. to 1400° C. for 3 h to 8 h. Under this condition, silicon nitride can chemically react with elemental magnesium, magnesium oxide, magnesium hydroxide, organic magnesium, elemental zinc, zinc oxide, zinc hydroxide, organic zinc, elemental zirconium, zirconium oxide, zirconium hydroxide, organic zirconium and other substances to obtain magnesium silicate, aluminum silicate, zinc silicate, zirconium silicate, magnesium zirconium silicate, aluminum zirconium silicate, zinc zirconium silicate, etc.

By way of example only, the sintering temperature is 1000° C., 1050° C., 1100° C., 1150° C., 1200° C., 1250° C., 1300° C., 1350° C., or 1400° C., and the sintering time is 3 h, 4 h, 5 h, 6 h, 7 h, or 8 h. Optionally, the core material is silicon nitride, and the sintering is performed at a temperature of 1300° C. to 1400° C. for 3 h to 8 h.

In another embodiment, the core material is silicon nitride, and the shell raw material is hydrated silicate, and during sintering, at least part of the hydrated silicate melts and undergoes mass transfer on the surface of the core 110 to form a silicate-containing shell 120.

During sintering, the shell raw material melts to undergo mass transfer on the surface of the silicon nitride core, and water is separated, so that a silicate shell 120 can be obtained, so that the composite material 100 has better thermal conductivity, and when it is used as a thermal conductive filler, the wear on the device when contacting the device is very small.

Optionally, the hydrated silicate includes one or more of hydrated magnesium silicate, hydrated sodium silicate, hydrated sodium aluminosilicate, and hydrated calcium aluminosilicate. The shell material obtained after sintering includes magnesium silicate, sodium silicate, sodium aluminosilicate, calcium aluminosilicate, etc.

Optionally, the sintering is performed at a temperature higher than a melting point of at least part of the hydrated silicate for 3 h to 8 h. For example, when the shell raw material is hydrated magnesium silicate (talcum powder), the sintering is performed at 850° C. to 1000° C. for 3 h to 8 h.

In some embodiments, D50₂ of the shell raw material is 0.05 μm to 10 μm, D50₃ of the silicon nitride core is 0.5 μm to 1000 μm, and 0.00001≤D50₂/D50₃≤0.1. The shell raw material with relatively small particle sizes is easy to coat on the surface of the silicon nitride core, so as to form a uniformly coated core-shell structure after subsequent sintering.

By way of example only, D50₂ of the shell raw material is 0.05 μm, 0.1 μm, 0.15 μm, 0.3 μm, 0.5 μm, 0.7 μm, 0.9 μm, 1.1 μm, 1.3 μm, 1.5 μm, 1.7 μm, 1.9 μm, 2 μm, 3 μm, 4 μm, 5 μm, 6 μm, 7 μm, 8 μm, 9 μm, or 10 μm; D50₃ of the silicon nitride core is 0.5 μm, 1 μm, 5 μm, 10 μm, 20 μm, 50 μm, 100 μm, 200 μm, 400 μm, 800 μm, or 1000 μm; and the value of D50₂/D50₃ is 0.00001, 0.00005, 0.0001, 0.0005, 0.001, 0.005, 0.01, 0.05, or 0.1.

In the present disclosure, D50₃ of the silicon nitride core is 0.5 μm to 1000 μm, and the composite material 100 has a D50₁ of 0.5 μm to 1000 μm. It does not mean that the particle size of the composite material 100 obtained after coating and sintering the core 110 is consistent with the particle size of the core 110. Generally, the particle size of the composite material 100 obtained after coating and sintering is slightly larger than that of the core 110, and the corresponding details are not given here.

Optionally, D50₃ of the silicon nitride core is 0.5 μm to 500 μm, and 0.0001≤D502/D50₃≤0.1. Matching the core material and the shell material that satisfy this condition can make the coating effect of the precursor better, thereby obtaining a more uniform shell 120 subsequently, so as to improve the thermal conductivity of the composite material 100 and reduce the hardness of the composite material 100.

Further, D50₃ of the silicon carbide core is 0.5 μm to 140 μm, and 0.0003≤D50₂/D50₃≤0.1.

Matching the silicon nitride core and the shell material that satisfy the condition can make the obtained composite material 100 more easily added to the matrix material as a thermal conductive filler, so as to facilitate its application in the field of thermal conductivity.

In some embodiments, the mass fraction of the shell raw material in the precursor is 1% to 30%. It is possible to form a better shell 120 after sintering and, to a certain extent, avoid the adverse effect of the excessive thickness of the shell 120 on the thermal conductivity.

By way of example only, the mass fraction of the shell raw material in the precursor is 1%, 3%, 5%, 8%, 10%, 15%, 20%, 25%, or 30%. Optionally, the mass fraction of the shell raw material in the precursor is 5% to 20%. The shell 120 can completely coat the core 110 and avoid the excessive thickness of the shell 120, so that the composite material 100 has better thermal conductivity and lower hardness.

In some embodiments, the method for forming the precursor includes: mixing the silicon nitride core, the shell raw material, and a coating aid, and then performing coating. By mixing and coating in conjunction with the coating aid, the shell raw material can be uniformly adhered to the surface of the silicon nitride core, and during the sintering process, the shell raw material will undergo mass transfer, and finally a relatively complete coating shell 120 is formed, and the shell 120 more uniformly coats the surface of the silicon nitride core.

Optionally, including a coating aid containing a silicon, which can make the shell raw material react with silicon nitride and also react with the coating aid, thereby obtaining a product with more uniform coating, better coating effect, and reduced agglomeration tendency, and the composite material has lower hardness and higher thermal conductivity.

Optionally, the coating aid includes tetraethyl orthosilicate. Tetraethyl orthosilicate can be used as a coating aid on the one hand and can further provide silicon on the other hand, so that the shell raw material can react with the silicon nitride core and can also react with tetraethyl orthosilicate, and finally a product with more uniform coating, better coating effect, and reduced agglomeration tendency is obtained, and the composite material 100 also has a higher thermal conductivity. Further, the coating aid is tetraethyl orthosilicate.

In other embodiments, the coating aid may also be polyvinyl butyral resin, acrylic resin, etc., which is not limited in the present disclosure, and any coating aid that can make the shell raw material better adhere to the surface of the silicon nitride core shall fall within the protection scope of the present disclosure.

In some embodiments, the mass fraction of the coating aid in the precursor is 1% to 15%. The coating effect can be better, and the performance of the composite material 100 can be prevented from being affected by excessive use of the coating aid.

By way of example only, the mass fraction of the coating aid in the precursor is 1%, 2%, 4%, 6%, 9%, 12%, or 15%. Optionally, the mass fraction of the coating aid in the precursor is 3% to 10%. The coating effect can be better, and excessive use of the coating aid can be avoided, so that more shell raw material can react with the silicon nitride core.

In some embodiments, the coating is performed by wet ball milling at a rotation speed of 200 r/min to 600 r/min for at least 1 h. Coating by means of wet ball milling can be performed in conjunction with the coating aid to make the shell raw material more uniformly coat the surface of the silicon nitride core, and avoid the agglomeration of the core 110 in the coating process of the raw material.

By way of example only, the rotation speed of the wet ball milling is 200 r/min, 250 r/min, 300 r/min, 350 r/min, 400 r/min, 450 r/min, 500 r/min, 550 r/min, or 600 r/min, and the duration of the wet ball milling is 1 h, 2 h, 3 h, 4 h, 5 h, 6 h, 7 h, 8 h, 9 h, or 10 h. Optionally, the rotation speed of the wet ball milling is 300 r/min to 500 r/min, and the duration of the wet ball milling is 1 h to 6 h.

### Method for Preparing the Third Kind of Composite Materials

The method includes: coating the surface of the core 110 (easily hydrolysable core) with shell raw material to form a precursor; sintering the precursor to make at least part of the shell raw material reacts with the core 110 and undergo mass transfer to form a shell 120 containing a metal salt, thereby obtaining the composite material 100. The core material has a thermal conductivity of at least 20 W/(m·K). The following takes the core 110 being aluminum nitride as an example for description.

The method for preparing the composite material 100 with the core 110 being aluminum nitride includes: coating the surface of the aluminum nitride core with shell raw material to form a precursor; and sintering the precursor to make at least part of the shell raw material reacts with the aluminum nitride core to form an aluminate-containing shell 120, thereby obtaining the composite material 100.

In the method, the shell raw material may be roughly coated first, and then the shell raw material can react with the surface layer of aluminum nitride while performing mass transfer in the subsequent sintering process, so that a relatively uniform and complete shell 120 can be formed on the surface of the aluminum nitride core, so as to satisfy the thermal conductivity of the composite material 100 and improve the hydrolytic stability of the composite material 100, so as to be used in a high-humidity environment.

In some embodiments, the tap density of the aluminum nitride core 110 is not lower than 2.0 g/cm³. The higher tap density of the core 110 can make the composite effect of the core 110 and the shell 120 better, thereby obtaining the composite material 100 with higher thermal conductivity and better hydrolysis stability.

By way of example only, the tap density of the aluminum nitride core is 2.0 g/cm³, 2.05 g/cm³, 2.10 g/cm³, 2.15 g/cm³, 2.20 g/cm³, 2.25 g/cm³, 2.30 g/cm³, 2.35 g/cm³, 2.40 g/cm³, or 2.45 g/cm³. Optionally, the tap density of the aluminum nitride core is 2.1 g/cm³ to 2.4 g/cm³.

The composite material 100 with higher thermal conductivity and better hydrolysis stability can be obtained.

In some embodiments, the core material is aluminum nitride, and the shell raw material includes at least one selected from zinc oxide, magnesium oxide, calcium oxide, potassium oxide, and silicon oxide. Aluminum nitride chemically reacts with the aforementioned shell raw material to obtain magnesium aluminate, zinc aluminate, calcium aluminate, potassium aluminate, aluminum silicate, etc., thereby in-situ forming an aluminate-containing shell 120 on the surface of the core 110, so that the composite material 100 has better thermal conductivity and better hydrolysis stability.

In some embodiments, D50₂ of the shell raw material is 0.05 μm to 10 μm, D50₃ of the aluminum nitride core is 0.5 μm to 1000 μm, and 0.00001≤D502/D50₃≤0.1. The shell raw material with relatively small particle size is easy to coat on the surface of the aluminum nitride core, so as to form a uniformly coated core-shell structure after subsequent sintering.

By way of example only, D50₂ of the shell raw material is 0.05 μm, 0.1 μm, 0.15 μm, 0.3 μm, 0.5 μm, 0.7 μm, 0.9 μm, 1.1 μm, 1.3 μm, 1.5 μm, 1.7 μm, 1.9 μm, 2 μm, 3 μm, 4 μm, 5 μm, 6 μm, 7 μm, 8 μm, 9 μm, or 10 μm; and D50₃ of the aluminum nitride core is 0.5 μm, 1 μm, 5 μm, 10 μm, 20 μm, 50 μm, 100 μm, 200 μm, 400 μm, 800 μm, or 1000 μm; and the value of D50₂/D50₃ is 0.00001, 0.00005, 0.0001, 0.0005, 0.001, 0.005, 0.01, 0.05, or 0.1.

In the present disclosure, D50₃ of the aluminum nitride core is 0.5 μm to 1000 μm, and the composite material 100 has a D50₁ of 0.5 μm to 1000 μm. It does not mean that the particle size of the composite material 100 obtained after coating and sintering the core 110 is consistent with the particle size of the core 110. Generally, the particle size of the composite material 100 obtained after coating and sintering is slightly larger than that of the core 110, and the corresponding details are not given here.

Optionally, D50₃ of the aluminum nitride core is 0.5 μm to 500 μm, and 0.0001≤D50₂/D50₃≤0.1. The matching of the core material and the shell material that satisfy this condition can make the coating effect of the precursor better, thereby obtaining a more uniform shell 120 subsequently, thereby improving the thermal conductivity and hydrolysis stability of the composite material 100.

Further, D50₃ of the aluminum nitride core is 0.5 μm to 140 μm, and 0.0003≤D502/D50₃≤0.1. Matching the silicon carbide core and the shell material that satisfy the condition can make the obtained composite material 100 more easily added to the matrix material as a thermal conductive filler, so as to facilitate its application in the field of thermal conductivity.

In some embodiments, the mass fraction of the shell raw material in the precursor is 1% to 30%. It is possible to form a better shell 120 after sintering and, to a certain extent, avoid the adverse effect of the excessive thickness of the shell 120 on the thermal conductivity.

By way of example only, the mass fraction of the shell raw material in the precursor is 1%, 3%, 5%, 8%, 10%, 15%, 20%, 25%, or 30%. Optionally, the mass fraction of the shell raw material in the precursor is 5% to 20%. This can enable the shell 120 to completely coat the core 110 and avoid excessive thickness of the shell 120, so that the composite material 100 has better thermal conductivity and hydrolysis stability.

In some embodiments, the method for forming the precursor includes: mixing the aluminum nitride core, shell raw material and a coating aid, and then performing coating. By mixing and coating in conjunction with the coating aid, the shell raw material can be uniformly adhered to the surface of the aluminum nitride core. During the sintering process, the shell raw material will undergo mass transfer, finally forming a relatively complete coating shell 120 that more uniformly coats the surface of the aluminum nitride core.

Optionally, the coating aid may be at least one selected from tetraethyl orthosilicate, polyvinyl butyral resin, and acrylic resin. The present disclosure is not limited, and any coating aid that can enable the shell raw material to better adhere to the surface of the silicon carbide core shall fall within the protection scope of the present disclosure.

In some embodiments, the mass fraction of the coating aid in the precursor is 1% to 15%. The coating effect can be better, and the performance of the composite material 100 can be prevented from being affected by excessive use of the coating aid.

By way of example only, the mass fraction of the coating aid in the precursor is 1%, 2%, 4%, 6%, 9%, 12%, or 15%. Optionally, the mass fraction of the coating aid in the precursor is 3% to 10%. This can ensure a better coating effect while avoiding excessive use of the coating aid, so that more shell raw material can react with the aluminum nitride core.

In some embodiments, the coating is performed by wet ball milling at a rotation speed of 200 r/min to 600 r/min for at least 1 h. Coating by means of wet ball milling may be performed in conjunction with the coating aid to make the shell raw material more uniformly coat the surface of the core 110, and avoid the agglomeration of the core 110 in the coating process of the raw material.

By way of example only, the rotation speed of the wet ball milling is 200 r/min, 250 r/min, 300 r/min, 350 r/min, 400 r/min, 450 r/min, 500 r/min, 550 r/min, or 600 r/min, and the duration of the wet ball milling is 1 h, 2 h, 3 h, 4 h, 5 h, 6 h, 7 h, 8 h, 9 h, or 10 h. Optionally, the rotation speed of the wet ball milling is 300 r/min to 500 r/min, and the duration of the wet ball milling is 1 h to 6 h.

In other embodiments, the coating device may be: a planetary ball milling device, a ball milling device, a sanding device, or a stirring device, etc.

In some embodiments, the core material is aluminum nitride, and the sintering is performed at a temperature of 1400° C. to 1800° C. for 3 h to 8 h. Under these conditions, aluminum nitride can chemically react with substances such as zinc oxide, magnesium oxide, calcium oxide, potassium oxide, and silicon oxide to obtain magnesium aluminate, zinc aluminate, calcium aluminate, potassium aluminate, aluminum silicate, etc.

By way of example only, the sintering temperature is 1400° C., 1450° C., 1500° C., 1550° C., 1600° C., 1650° C., 1700° C., 1750° C., or 1800° C., and the sintering time is 3 h, 4 h, 5 h, 6 h, 7 h, or 8 h. Optionally, the core material is aluminum nitride, and the sintering is performed at a temperature of 1500° C. to 1700° C. for 3 h to 8 h.

In order to make the objectives, technical solutions, and advantages of the embodiments of the present disclosure clearer, the technical solutions in the examples of the present disclosure will be described clearly and completely below. Where specific conditions are not specified in the examples, they are implemented according to conventional conditions or the conditions suggested by the manufacturer. Where manufacturers of the reagents or instruments used are not indicated, they are all conventional products that can be purchased commercially.

### EMBODIMENT

This embodiment provides a method for preparing a composite material, which includes the following steps:
(1) Mixing the core, coating aid, and shell raw material with pure water, placing them in a planetary ball milling device, ball-milling and mixing at 500 r/min for 6 h, suction-filtering the slurry, drying the powder in a 90° C. oven for 12 h, sieving through a 60-mesh sieve for later use, and obtaining a precursor.
(2) Placing the precursor in an alumina sagger, and naturally cooling to room temperature after sintering to obtain the composite material.

The preparation conditions of the composite materials are shown in Tables 1 to 5. In Table 1, the core is made of silicon carbide (thermal conductivity is 90 W/(m·K)), and its particle size distribution is: D10 is 88 μm, D50 is 124 μm, D90 is 186 μm, and the tap density is 1.94 g/cm³. In Table 2, the shell raw material is all magnesium oxide, the particle size D50 of magnesium oxide is 1.9 μm, and the mass fraction of magnesium oxide in the precursor is 10%. In Table 3, the coating aid is tetraethyl orthosilicate. In Table 5, the silicon nitride has a thermal conductivity of 60 W/(m·K), and the aluminum nitride has a thermal conductivity of 100 W/(m·K).

TABLE 1
Preparation conditions of the composite material

| | Silicon carbide core | | | | | | | | | Sintering condition | |
|---|---|---|---|---|---|---|---|---|---|---|---|
| | Particle size | | | Tap | Shell raw material | | | Coating aid | | Sintering | |
| | distribution (μm) | | | density | | D50 | Amount | | Amount | temperature | Sintering |
| | D10 | D50 | D90 | (g/cm³) | Composition | (μm) | (%) | Composition | (%) | (° C.) | time (h) |
| R1 | 88 | 124 | 186 | 1.94 | Magnesium | 1.9 | 10 | Tetraethyl | 4 | 1300 | 8 |
| | | | | | oxide | | | orthosilicate | | | |
| R2 | 88 | 124 | 186 | 1.94 | Magnesium | 1.9 | 30 | | 2 | 1400 | 3 |
| | | | | | oxide | | | | | | |
| R3 | 88 | 124 | 186 | 1.94 | Magnesium | 1.9 | 30 | | 2 | 1300 | 5 |
| | | | | | oxide | | | | | | |
| R4 | 88 | 124 | 186 | 1.94 | Magnesium | 1.9 | 20 | | 2 | 1300 | 5 |
| | | | | | oxide | | | | | | |
| R5 | 88 | 124 | 186 | 1.94 | Magnesium | 1.9 | 8 | | 4 | 1300 | 8 |
| | | | | | oxide | | | | | | |
| R6 | 88 | 124 | 186 | 1.94 | Magnesium | 1.9 | 8 | | 5 | 1300 | 8 |
| | | | | | oxide | | | | | | |
| R7 | 88 | 124 | 186 | 1.94 | Magnesium | 1.9 | 8 | | 10 | 1300 | 8 |
| | | | | | oxide | | | | | | |
| R8 | 88 | 124 | 186 | 1.94 | Magnesium | 1.9 | 10 | Polyvinyl | 4 | 1300 | 5 |
| | | | | | oxide | | | butyral resin | | | |
| R9 | 88 | 124 | 186 | 1.94 | Magnesium | 1.9 | 10 | Acrylic | 4 | 1300 | 5 |
| | | | | | oxide | | | resin | | | |
| D1 | 88 | 124 | 186 | 1.94 | Magnesium | 1.9 | 10 | Tetraethyl | 4 | / | / |
| | | | | | oxide | | | orthosilicate | | | |
| D2 | 88 | 124 | 186 | 1.94 | Magnesium | 1.9 | 10 | | 4 | / | / |
| | | | | | silicate | | | | | | |
| D3 | 88 | 124 | 186 | 1.94 | / | / | / | / | / | 1300 | 8 |
| | | | | | | | | | | (aerobic | |
| | | | | | | | | | | environment) | |
| D4 | 88 | 124 | 186 | 1.94 | / | / | / | / | / | / | / |

TABLE 2
Preparation conditions of the composite material

| | Silicon carbide core | | | | | | | | | Sintering condition | |
|---|---|---|---|---|---|---|---|---|---|---|---|
| | Particle size | | | Tap | Shell raw material | | | Coating aid | | Sintering | |
| | distribution (μm) | | | density | | D50 | Amount | | Amount | temperature | Sintering |
| | D10 | D50 | D90 | (g/cm³) | Composition | (μm) | (%) | Composition | (%) | (° C.) | time (h) |
| R10 | 102 | 145 | 213 | 1.84 | Magnesium | 1.9 | 10 | Tetraethyl | 5 | 1300 | 8 |
| | | | | | oxide | | | orthosilicate | | | |
| R11 | 76 | 116 | 174 | 1.91 | Magnesium | 1.9 | 10 | | 5 | 1300 | 8 |
| | | | | | oxide | | | | | | |
| R12 | 90 | 127 | 191 | 2.01 | Magnesium | 1.9 | 10 | | 5 | 1300 | 8 |
| | | | | | oxide | | | | | | |
| R13 | 85 | 119 | 179 | 2.10 | Magnesium | 1.9 | 10 | | 5 | 1300 | 8 |
| | | | | | oxide | | | | | | |
| R14 | 93 | 136 | 200 | 1.86 | Magnesium | 1.9 | 10 | | 4 | 1300 | 8 |
| | | | | | oxide | | | | | | |

TABLE 3
Preparation conditions of the composite material

| | Silicon carbide core | | | | Shell raw material | | | | | Sintering condition | |
|---|---|---|---|---|---|---|---|---|---|---|---|
| | Particle size | | | Tap | | D50 median | | Coating aid | | Sintering | |
| | distribution (μm) | | | density | | particle | Amount | | Amount | temperature | Sintering |
| | D10 | D50 | D90 | (g/cm³) | Composition | size (μm) | (%) | Composition | (%) | (° C.) | time (h) |
| R15 | 76 | 116 | 174 | 1.91 | Talcum | 1.9 | 10 | Tetraethyl | 4 | 1000 | 2 |
| | | | | | powder | | | orthosilicate | | | |
| R16 | 90 | 127 | 191 | 1.97 | Magnesium | 0.5 | 30 | | 2 | 1300 | 1 |
| | | | | | oxide | | | | | | |
| R17 | 88 | 124 | 187 | 1.98 | Magnesium | 1.9 | 30 | | 2 | 1400 | 3 |
| | | | | | oxide | | | | | | |
| R18 | 88 | 124 | 187 | 1.98 | Magnesium | 1.9 | 30 | | 2 | 1300 | 5 |
| | | | | | oxide | | | | | | |
| R19 | 88 | 124 | 187 | 1.98 | Magnesium | 1.9 | 20 | | 2 | 1300 | 5 |
| | | | | | oxide | | | | | | |

TABLE 4
Preparation conditions of the composite material

| | Silicon carbide core | | | | Shell raw material | | | | | Sintering condition | |
|---|---|---|---|---|---|---|---|---|---|---|---|
| | Particle size | | | Tap | | D50 median | | Coating aid | | Sintering | |
| | distribution (μm) | | | density | | particle | Amount | | Amount | temperature | Sintering |
| | D10 | D50 | D90 | (g/cm³) | Composition | size (μm) | (%) | Composition | (%) | (° C.) | time (h) |
| R20 | 86 | 125 | 190 | 1.96 | Magnesium | 0.5 | 20 | Tetraethyl | 2 | 1300 | 2 |
| | | | | | oxide | | | orthosilicate | | | |
| | | | | | Aluminum | 0.5 | 20 | | | | |
| | | | | | oxide | | | | | | |
| R21 | 92 | 128 | 191 | 1.96 | Zinc oxide | 0.5 | 30 | | 5 | 1000 | 2 |
| R22 | 86 | 125 | 190 | 1.96 | Zinc oxide | 0.5 | 30 | | 7 | 1000 | 3 |
| R23 | 85 | 129 | 197 | 1.94 | Zinc oxide | 0.5 | 30 | | 10 | 900 | 3 |
| R24 | 80 | 123 | 191 | 1.98 | Zinc oxide | 0.5 | 20 | | 5 | 1000 | 2 |
| | | | | | Aluminum | 0.5 | 20 | | | | |
| | | | | | oxide | | | | | | |
| R25 | | | | | Zinc oxide | 0.5 | 25 | | | | |
| | | | | | Aluminum | 0.5 | 20 | | | | |
| | | | | | oxide | | | | | | |
| R26 | 90 | 127 | 191 | 1.97 | Zinc oxide | 0.5 | 40 | | 5 | 1000 | 2 |
| R27 | | | | | | 0.5 | 25 | | 5 | 1240 | 5 |
| R28 | | | | | | 0.5 | 5 | | 3 | 1300 | 8 |
| R29 | 89 | 130 | 193 | 1.96 | Aluminum | 0.5 | 20 | | 5 | 1240 | 5 |
| | | | | | oxide | | | | | | |
| R30 | | | | | Zirconium | 0.5 | 20 | | 5 | 1300 | 8 |
| | | | | | oxide | | | | | | |
| R31 | | | | | Yttria | 0.5 | 20 | | 5 | 1300 | 8 |
| R32 | | | | | Cerium | 0.5 | 20 | | 5 | 1300 | 8 |
| | | | | | dioxide | | | | | | |
| R33 | 52 | 90 | 147 | 2.1 | Magnesium | 1.9 | 9 | | 5 | 1300 | 8 |
| | | | | | oxide | | | | | | |
| R34 | 42 | 69 | 104 | 2.11 | Magnesium | 1.3 | 10 | | 5 | 1280 | 8 |
| | | | | | oxide | | | | | | |
| R35 | 22 | 41 | 67 | 2.15 | Magnesium | 1.3 | 10 | | 5 | 1280 | 8 |
| | | | | | oxide | | | | | | |

TABLE 5
Preparation conditions of the composite material

| | Core | | | | | | | | | | Sintering condition | |
|---|---|---|---|---|---|---|---|---|---|---|---|---|
| | | Particle size | | | Tap | Shell raw material | | | Coating aid | | Sintering | |
| | | distribution (μm) | | | density | | D50 | Amount | | Amount | temperature | Sintering |
| | Composition | D10 | D50 | D90 | (g/cm³) | Composition | (μm) | (%) | Composition | (%) | (° C.) | time (h) |
| R36 | Silicon | 89 | 120 | 193 | 1.98 | Magnesium | 0.5 | 5 | Tetraethyl | 3 | 1300 | 2 |
| | nitride | | | | | oxide | | | orthosilicate | | | |
| R37 | Aluminum | 85 | 120 | 198 | 2.00 | Zinc oxide | 0.5 | 8 | | 3 | 1300 | 2 |
| | nitride | | | | | | | | | | | |
| D5 | Silicon | 89 | 120 | 193 | 1.98 | / | / | / | / | / | / | / |
| | nitride | | | | | | | | | | | |
| D6 | Aluminum | 85 | 120 | 198 | 2.00 | / | / | / | / | / | / | / |
| | nitride | | | | | | | | | | | |

The composite material is screened through a 25-μm sieve to remove the shell raw material not coating the surface of the core, and then the parameters and performance of the composite materials provided in the screened examples and comparative examples are tested. The results are shown in Tables 6 to 10. The test methods are as follows:

(1) The test method for tap density (unit: g/cm³) is as follows: A tap density meter is adopted. A graduated cylinder filled with powder or particles is fixed on a mechanical vibration device. The vibration motor drives the mechanical vibration device to vibrate vertically up and down, and the graduated cylinder filled with powder or particles vibrates rhythmically with the mechanical vibration device. With the increase in the number of vibrations, the powder or particles in the graduated cylinder are gradually tapped. After the number of vibrations reaches the set number, the mechanical vibration device stops vibrating, and the volume of the graduated cylinder is read. According to the definition of density, that is, mass divided by volume, the tap density of the tapped powder or particles is thus obtained.

(2) The test method for specific surface area (unit: m²/g) is in accordance with GB/T 19587-2004 Determination of the specific surface area of solids by gas adsorption using the BET method.

(3) The calculation method for the ratio of shell thickness to particle size is: (D50 particle size of the composite material−D50 particle size of the core)/D50 particle size of the composite material.

(4) The test method for the mass fraction of the core and the shell (unit: %) is: after XRD detection, analysis is performed by the RIR method. The basic principle is that there is a ratio of the integrated intensity of the strongest diffraction peak of the shell material to that of the core material, and this ratio is the RIR value. By calculating the integral strength/RIR value of the shell material, the integral strength of the core material can be converted. For a mixture, all components in the substance are converted by this method, and finally the percentage content of a certain component can be obtained by the normalization method.

(5) The test method for the particle size distribution (unit: μm) of the composite material is: using a BT particle size analyzer to detect by GB/T 19077-2016 Particle size analysis Laser diffraction methods.

(6) Mass fraction of screen underflow (%): Taking a composite material with a bulk volume of 200 mL, weighing its mass as M kg, placing it in a container (with a volume of 500 mL) equipped with a stirring device, stirring at 500 r/min for 10 min, and then screening (the sieve mesh size of R34 is 18 μm, and the sieve mesh size of other examples is 25 μm). The mass of the screen underflow is detected as M₁ kg, and M₁/M×100% is calculated as the mass fraction of the screen underflow.

(7) The test methods for the viscosity (unit: mPa·s) of the silicone mixture are as follows: When D50 is 80 μm to 150 μm, the test method is: 4.8 parts by weight of vinyl silicone oil with a viscosity of 100 mPa·s, 20 parts by weight of the composite material, 21 parts by weight of spherical alumina NSM-1S, 30 parts by weight of spherical alumina BAK-10, and 25 parts by weight of spherical alumina BAK-120 are mixed, first treated for 1 min with a rotation speed of 1100 r/min and a vacuum degree of 1000 Pa; then treated for 1 min with a rotation speed of 1500 r/min and a vacuum degree of 40 Pa to obtain the silicone mixture; and then using an Anton Paar rheometer at 25° C. and shear rates of 0.1 to 100 s⁻¹, the viscosity of the silicone mixture at 1 s⁻¹ is measured.

When D50 is 60 μm to 80 μm, the test method is: 5.2 parts by weight of vinyl silicone oil with a viscosity of 100 mPa·s, 52 parts by weight of the composite material, 15 parts by weight of spherical alumina NSM-1S, and 33 parts by weight of spherical alumina BAK-5 are mixed, first treated for 1 min with a rotation speed of 1100 r/min and a vacuum degree of 1000 Pa; then treated for 1 min with a rotation speed of 1500 r/min and a vacuum degree of 40 Pa to obtain the silicone mixture; and then using an Anton Paar rheometer at 25° C. and shear rates of 0.1 to 100 s⁻¹, the viscosity of the silicone mixture at 1 s⁻¹ is measured.

When D50 is 30 μm to 50 μm, the test method is: 5.6 parts by weight of vinyl silicone oil with a viscosity of 100 mPa·s, 60 parts by weight of the composite material, and 40 parts by weight of spherical alumina BAK-5 are mixed, first treated for 1 min with a rotation speed of 1100 r/min and a vacuum degree of 1000 Pa; then treated with a rotation speed of 1500 r/min and a vacuum degree of 40 Pa for 1 min to obtain the silicone mixture; and then using an Anton Paar rheometer at 25° C. and shear rates of 0.1 to 100 s⁻¹, the viscosity of the silicone mixture at 1 s⁻¹ is measured.

(8) The test method for the thermal conductivity (unit: W/(m·K)) of the gasket is: curing the silicone mixture in detection (7) at 120° C. for 30 min to form a silicone gasket, and then testing the thermal conductivity of the gasket by the Hot Disk method.

(9) The test method for the breakdown voltage (unit: KV/mm) of the gasket is: testing the silicone gasket in detection (8) according to ASTM D149 Standard Test Method for Dielectric Breakdown Voltage and Dielectric Strength of Solid Electrical Insulating Materials at Commercial Power Frequencies to obtain the breakdown voltage of the gasket.

(10) The test method for the aging resistance (unit: KV/mm) of the gasket is: placing the silicone gasket in detection (8) under the conditions of 85% humidity and 85° C. for 1000 h, and testing its breakdown voltage (unit: KV/mm) according to the method in detection (9) to obtain the aging performance of the composite material.

(11) The test method for the hardness of the gasket is: testing the silicone gasket in detection (8) according to ASTM D2240 Standard Test Method for Rubber Property-Durometer Hardness.

(12) The test method for the hydrolysis stability of the gasket is: mixing the composite material and pure water at the mass fraction of 1:10, detecting the pH value of the mixed solution; then heating the solution temperature to 90° C., placing it for 100 h, and then detecting the pH value of the mixed solution; mixing aluminum nitride and pure water at a mass fraction of 1:10, detecting the pH value of the mixed solution; and heating the solution temperature to 90° C., placing it for 3 h, and then detecting the pH value of the mixed solution.

TABLE 6
Parameters and performance of the composite material

| | Parameters of the composite material | | | | | | | | | | | | |
|---|---|---|---|---|---|---|---|---|---|---|---|---|---|
| | | | Ratio | | | | | | | | | | |
| | | | of shell | | | | | | | | | | |
| | | Specific | thickness | Mass | Main | Particle size | | | Mass of | performance of the composite material | | | |
| | Tap | surface | to particle | fraction | composition | distribution | | | screen | | Thermal | Breakdown | Aging |
| | density | area | size | of core | of shell | D10 | D50 | D90 | underflow | Viscosity | conductivity | voltage | resistance |
| R1 | 1.9 | 0.042 | 0.0463 | 71 | Magnesium | 92 | 130 | 194 | 0.01 | 1459980 | 8 | 6.8 | 6.6 |
| R2 | 1.86 | 0.056 | 0.067 | 57 | silicate | 95 | 133 | 198 | 0.03 | 1529470 | 7.8 | 6.5 | 6.4 |
| R3 | 1.88 | 0.051 | 0.053 | 68 | | 93 | 131 | 195 | 0.035 | 1722590 | 7.8 | 6.8 | 6.7 |
| R4 | 1.89 | 0.048 | 0.0463 | 70 | | 93 | 130 | 195 | 0.018 | 1677010 | 7.8 | 6.4 | 6.3 |
| R5 | 1.9 | 0.044 | 0.0463 | 71 | | 91 | 130 | 193 | 0.005 | 1380250 | 7.7 | 6.7 | 6.7 |
| R6 | 1.9 | 0.04 | 0.0463 | 71 | | 92 | 130 | 194 | 0.005 | 1222680 | 7.5 | 6.8 | 6.6 |
| R7 | 1.9 | 0.051 | 0.0463 | 70 | | 92 | 130 | 195 | 0.006 | 1554760 | 7.9 | 6.7 | 6.5 |
| R8 | 1.9 | 0.1162 | 0.0658 | 90 | | 82 | 119 | 189 | 0.025 | 1315000 | 7.6 | 6.2 | 6.1 |
| R9 | 1.86 | 0.0863 | 0.0672 | 88 | | 83 | 118 | 189 | 0.02 | 1260850 | 7.9 | 6.4 | 6.3 |
| D1 | 1.91 | 0.562 | / | 91 | Magnesium | 78 | 119 | 177 | 7.5 | 1985940 | 8 | 1.3 | 0.8 |
| | | | | | oxide, | | | | | | | | |
| | | | | | tetraethyl | | | | | | | | |
| | | | | | orthosilicate | | | | | | | | |
| D2 | 1.88 | 0.415 | / | 90 | Magnesium | 82 | 120 | 188 | 7.8 | 1943540 | 7.8 | 1.4 | 0.7 |
| | | | | | silicate, | | | | | | | | |
| | | | | | tetraethyl | | | | | | | | |
| | | | | | orthosilicate | | | | | | | | |
| D3 | 1.91 | 0.0265 | / | 98 | Silicon | 83 | 125 | 191 | None | 1260376 | 6.7 | 5.8 | |
| | | | | | oxide | | | | | | | | |
| D4 | 1.94 | / | / | / | / | 88 | 124 | 186 | / | 1213740 | 8.4 | 1.2 | 1 |

It can be seen from Tables 1 and 6 that the amount of screen underflow in the composite materials provided in Examples R1 to R9 of the present disclosure was very small, indicating that the combination of the shell and the core in the composite material was very good, and the material basically did not break or separate under stirring conditions. When the composite material was added to vinyl silicone oil as a thermal conductive filler, the obtained silicone mixture had a moderate viscosity, a high thermal conductivity, and a high breakdown voltage. At the same time, after the aging test, its breakdown voltage basically did not change, indicating better aging resistance.

In D1 and D2, the shell raw material was coated but not sintered. After the obtained composite material was stirred, the amount of screen underflow was large, the viscosity of the silicone mixture formed by the composite material was very high, and the breakdown voltage of the gasket was very low. The inventors speculate that the reason may be that during the stirring and mixing of the composite raw material with vinyl silicone oil, the shell raw material was separated from the core, resulting in more shell raw material independently entering the silicone mixture, increasing the viscosity of the silicone mixture. At the same time, since the shell powder was separated from the core, the core was exposed, resulting in a very low breakdown voltage of the gasket. At the same time, after the aging test, the breakdown voltage was further reduced, indicating poor aging resistance.

In D3, silicon carbide was directly sintered in an aerobic environment. Although silicon dioxide could be formed on the surface of silicon carbide, the silicone mixture formed by the obtained composite material had a lower viscosity, and the breakdown voltage of the gasket could be slightly increased (compared with pure silicon carbide). However, the increase in the breakdown voltage of the gasket was not high, and the thermal conductivity of the gasket was small.

In D4, pure silicon carbide was added to the silicone mixture as a thermal conductive filler, and the formed gasket had a low breakdown voltage.

By comparing R2, R3, and R4, it can be seen that when the shell raw material was basically the same (R2 and R3), the longer the sintering time (R3), the better the performance of the obtained composite material. When sintering at 1300° C. for 5 h (R3 and R4), and the proportion of magnesium oxide in the shell raw material was 30%, the obtained composite material had better performance, indicating that when the sintering temperature was lower and the sintering time was relatively short, the more the amount of shell raw material added, the more the reaction between the shell raw material and the core, thereby making the performance of the composite material better.

Compared with R8 and R9, in R1, the core was silicon carbide, and the coating aid was tetraethyl orthosilicate. When the obtained composite material was added to vinyl silicone oil as a thermal conductive filler, the silicone mixture obtained after curing into a silicone gasket had higher thermal conductivity and higher breakdown voltage. In R8 and R9, the proportion of the core was high. The inventors speculate that when the coating aid was polyvinyl butyral resin or acrylic resin, more raw material did not react, resulting in fewer reactions of the core material, and the final composite material had a lower breakdown voltage.

TABLE 7
Parameters and performance of the composite material

| | Parameters of the composite material | | | | | | | | | | | | |
|---|---|---|---|---|---|---|---|---|---|---|---|---|---|
| | | | Ratio | | | | | | | | | | |
| | | | of shell | | | | | | | | | | |
| | | Specific | thickness | Mass | Main | Particle size | | | Mass of | performance of the composite material | | | |
| | Tap | surface | to particle | fraction | composition | distribution | | | screen | | Thermal | Breakdown | Aging |
| | density | area | size | of core | of shell | D10 | D50 | D90 | underflow | Viscosity | conductivity | voltage | resistance |
| R10 | 1.80 | 0.1026 | 0.052 | 69 | Magnesium | 108 | 153 | 221 | 0.01 | 1823560 | 7.9 | 6.3 | 6.2 |
| R11 | 1.83 | 0.0911 | 0.042 | 72 | silicate | 81 | 122 | 180 | 0.008 | 1516732 | 7.7 | 6.8 | 6.4 |
| R12 | 1.95 | 0.0872 | 0.052 | 70 | | 95 | 134 | 199 | 0.007 | 1465980 | 7.8 | 6.8 | 6.8 |
| R13 | 2.04 | 0.0572 | 0.048 | 70 | | 89 | 125 | 187 | 0.005 | 1135387 | 7.8 | 6.8 | 6.7 |
| R14 | 1.80 | 0.1402 | 0.049 | 71 | | 98 | 141 | 208 | 0.01 | 1942280 | 7.8 | 6.5 | 6.6 |

It can be seen from Tables 2 and 7 that when the composite materials provided in Examples R11 to R13 of the present disclosure were added to vinyl silicone oil as thermal conductive fillers, the obtained silicone mixture had a lower viscosity, higher thermal conductivity, and a higher breakdown voltage (compared with R10 and R14). At the same time, after the aging test, its breakdown voltage basically did not change, indicating better aging resistance. From the above, it can be seen that when the tap density of the silicon carbide core is between 1.90 g/cm³ and 2.1 g/cm³, the performance of the composite material is better.

TABLE 8
Parameters and performance of the composite material

| | Parameters of the composite material | | | | | | | | | | | | |
|---|---|---|---|---|---|---|---|---|---|---|---|---|---|
| | | | Ratio | | | | | | | | | | |
| | | | of shell | | | | | | | | | | |
| | | Specific | thickness | Mass | Main | Particle size | | | Mass of | performance of the composite material | | | |
| | Tap | surface | to particle | fraction | composition | distribution | | | screen | | Thermal | Breakdown | Aging |
| | density | area | size | of core | of shell | D10 | D50 | D90 | underflow | Viscosity | conductivity | voltage | resistance |
| R15 | 1.59 | 0.1232 | 0.047 | 90 | Magnesium | 87 | 130 | 205 | 0.026 | 1630290 | 7.7 | 6.2 | 6 |
| R16 | 1.9 | 0.0880 | 0.052 | 72 | silicate | 91 | 134 | 198 | 0.023 | 1463200 | 7.5 | 5.6 | 5.4 |
| R17 | 1.89 | 0.0985 | 0.075 | 57.3 | | 95 | 134 | 200 | 0.02 | 1757120 | 8 | 6.3 | 6.4 |
| R18 | 1.9 | 0.0969 | 0.0462 | 68 | | 91 | 130 | 196 | 0.018 | 1722590 | 7.8 | 6.8 | 6.8 |
| R19 | 1.9 | 0.0960 | 0.0462 | 70 | | 92 | 130 | 195 | 0.015 | 1677010 | 7.8 | 6.4 | 6.4 |

According to Tables 3 and 8, in Example R15 of the present disclosure, the shell raw material was talcum powder. After sintering, magnesium silicate melted while simultaneously undergoing dehydration, yielding a composite material with a magnesium silicate shell. The silicone mixture formed by the composite material formed a gasket after curing, and the gasket had both high thermal conductivity and breakdown voltage. The inventors speculate that during the melting of talcum powder at high temperature, mass transfer occurred on the surface of the silicon carbide shell, and a composite material with a better coating effect could also be obtained.

Compared with R16, in R17 to R19, when D50₃ of the silicon carbide core was about 125 m and D50₂ of the shell raw material was about 2 μm, the prepared composite material was such that the silicone mixture formed by the composite material formed a gasket after curing, and the gasket had both high thermal conductivity and breakdown voltage. The inventors speculate that when the core material has a D50₃ of 100 μm to 140 μm and D50₂ of the shell raw material is 1.5 μm to 2 μm, the obtained composite material has better performance.

TABLE 9
Parameters and performance of the composite material size

| | Parameters of the composite material | | | | | | | | | | | | |
|---|---|---|---|---|---|---|---|---|---|---|---|---|---|
| | | | Ratio | | | | | | | | | | |
| | | | of shell | | | | | | | | | | |
| | | Specific | thickness | Mass | Main | Particle size | | | Mass of | performance of the composite material | | | |
| | Tap | surface | to particle | fraction | composition | distribution | | | screen | | Thermal | Breakdown | Aging |
| | density | area | size | of core | of shell | D10 | D50 | D90 | underflow | Viscosity | conductivity | voltage | resistance |
| R20 | 1.9 | 0.0975 | 0.053 | 65 | Magnesium | 92 | 132 | 198 | 0.033 | 1690390 | 7.8 | 6.5 | 6.5 |
| | | | | | silicate and | | | | | | | | |
| | | | | | magnesium | | | | | | | | |
| | | | | | aluminate | | | | | | | | |
| R21 | 1.93 | 0.0206 | 0.0376 | 77 | Zinc | 94 | 133 | 195 | 0.02 | 1061290 | 8.2 | 4.3 | 4.2 |
| | | | | | silicate | | | | | | | | |
| R22 | 1.93 | 0.0320 | 0.0384 | 76 | Zinc | 86 | 130 | 195 | 0.016 | 1152760 | 7.6 | 3.9 | 3.8 |
| | | | | | silicate | | | | | | | | |
| R23 | 1.9 | 0.0220 | 0.037 | 83 | Zinc | 88 | 134 | 202 | 0.018 | 1080578 | 7.9 | 4.4 | 4.4 |
| | | | | | silicate | | | | | | | | |
| R24 | 1.91 | 0.1126 | 0.039 | 83 | Zinc | 83 | 128 | 195 | 0.035 | 2214680 | 8.1 | 5.3 | 5.3 |
| | | | | | silicate | | | | | | | | |
| | | | | | and zinc | | | | | | | | |
| | | | | | aluminate | | | | | | | | |
| R25 | 1.91 | 0.1063 | 0.039 | 84 | Zinc | 83 | 128 | 195 | 0.03 | 2040690 | 8 | 3 | 3 |
| | | | | | silicate | | | | | | | | |
| | | | | | and zinc | | | | | | | | |
| | | | | | aluminate | | | | | | | | |
| R26 | 1.93 | 0.0378 | 0.0522 | 68 | Zinc | 94 | 134 | 201 | 0.032 | 1186420 | 7.9 | 4.4 | 4.3 |
| | | | | | silicate | | | | | | | | |
| R27 | 1.9 | 0.0426 | 0.066 | 53 | Zinc | 96 | 136 | 205 | 0.017 | 1283900 | 7.7 | 4.2 | 4.2 |
| | | | | | silicate | | | | | | | | |
| R28 | 1.9 | 0.4650 | 0.0593 | 56 | Zinc | 94 | 135 | 203 | 0.003 | 1479630 | 7.8 | 4.4 | 4.4 |
| | | | | | silicate | | | | | | | | |
| R29 | 1.89 | 0.1325 | 0.0579 | 65 | Aluminum | 94 | 138 | 202 | 0.035 | 2519800 | 8 | 5.5 | 5.3 |
| | | | | | silicate | | | | | | | | |
| R30 | 1.96 | 0.0662 | 0.045 | 65 | Zirconium | 91 | 136 | 138 | 0.025 | 1765302 | 7.6 | 5.2 | 5 |
| | | | | | silicate | | | | | | | | |
| R31 | 1.96 | 0.055 | 0.045 | 70 | Yttrium | 92 | 135 | 197 | 0.023 | 1713782 | 7.5 | 5.4 | 5.3 |
| | | | | | silicate | | | | | | | | |
| R32 | 1.96 | 0.046 | 0.045 | 71 | Cerium | 90 | 134 | 200 | 0.028 | 1658305 | 7.6 | 5.6 | 5.4 |
| | | | | | silicate | | | | | | | | |
| R33 | 2.12 | 0.056 | 0.045 | 73 | Magnesium | 56 | 95 | 152 | 0.001 | 1680350 | 7.6 | 7 | 7 |
| | | | | | silicate | | | | | | | | |
| R34 | 2.15 | 0.062 | 0.05 | 74 | Magnesium | 45 | 73 | 110 | 0.002 | 605356 | 5.3 | 6.8 | 6.7 |
| | | | | | silicate | | | | | | | | |
| R35 | 2.1 | 0.073 | 0.06 | 75 | Magnesium | 24 | 43 | 71 | 0.003 | 150450 | 4 | 6.6 | 6.6 |
| | | | | | silicate | | | | | | | | |

Combining Tables 4 and 9, it can be seen that in addition to the composite material with silicon carbide as the core and magnesium silicate as the shell, composite materials could also be formed with silicon carbide as the core and a mixture of magnesium silicate and magnesium aluminate as the shell (R20), or zinc silicate as the shell (R21 to R23, R26 to R28), or a mixture of zinc silicate and zinc aluminate as the shell (R24 and R25), or aluminum silicate as the shell (R29), or zirconium silicate as the shell (R30), or yttrium silicate as the shell (R31), or cerium silicate as the shell (R32). The inventors speculate that any substance that can chemically react with the core silicon carbide under sintering conditions can be used as a shell raw material to obtain composite materials with shells of various compositions. Comparing R24 with R26, compared with the shell material being zinc silicate (R26), the shell material containing both zinc silicate and zinc aluminate (R24) resulted in a composite material with better performance. The silicone mixture formed by the composite material formed a gasket after curing, and the gasket had both high thermal conductivity and breakdown voltage. The inventors speculate that the addition of zinc aluminate increased the thermal conductivity of the composite material and also increased the breakdown voltage.

Comparing R24 with R25, a higher addition amount of zinc silicate (R25) instead affected the breakdown voltage of the composite material. The inventors speculate that if the shell materials were zinc aluminate and magnesium silicate, and the content of magnesium silicate was 20% to 50%, the performance of the composite material could be better.

From Tables 6 to 9, it can be seen that the composite material with silicon carbide as the core and magnesium silicate as the shell had better performance. In the composite material, when the core is silicon carbide, the proportion of the core was 60% to 75%, and the shell was magnesium silicate, the obtained composite material had better performance.

From Tables 6 to 9, it can be seen that when the core was silicon carbide, the shell was magnesium silicate, the proportion of the core was 60% to 75%, and the viscosity of the thermal conductive mixture was 1×10⁶ mPa·s to 1.6×10⁶ mPa·s, the composite material had better performance.

TABLE 10
Parameters and performance of the composite material

| | Parameters of the composite material | | | | | | | | | | | | |
|---|---|---|---|---|---|---|---|---|---|---|---|---|---|
| | | | Ratio of | | | | | | | | | | |
| | | | shell | | | | | | | | | | |
| | | Specific | thickness | Mass | Main | Particle size | | | Mass of | performance of the composite material | | | |
| | Tap | surface | to particle | fraction | composition | distribution (μm) | | | screen | | Thermal | | Hydrolysis |
| | density | area | size | of core | of shell | D10 | D50 | D90 | underflow | Viscosity | conductivity | Hardness | stability |
| R36 | 1.95 | 0.0360 | 0.032 | 90 | Magnesium | 92 | 124 | 195 | 0.01 | 1364320 | 7.6 | 7 | / |
| | | | | | silicate | | | | | | | | |
| R37 | 1.97 | 0.0180 | 0.024 | 90 | Zinc | 93 | 123 | 196 | 0.015 | 1105720 | 8 | / | The pH |
| | | | | | aluminate | | | | | | | | increases |
| | | | | | | | | | | | | | from 6.6 |
| | | | | | | | | | | | | | to 10.5. |
| D5 | 1.98 | / | / | / | / | 89 | 120 | 193 | / | 1136505 | 7.8 | 9.3 | / |
| D6 | 2.00 | 2.00 | / | / | / | 85 | 120 | 198 | / | 1005682 | 8.1 | / | The pH |
| | | | | | | | | | | | | | increases |
| | | | | | | | | | | | | | from 7.13 |
| | | | | | | | | | | | | | to 11.5. |

It can be seen from Tables 5 and 10 that in R36, the composite material had low hardness. When used as a thermal conductive filler, it could reduce the wear of the composite material on the device, and had better thermal conductivity.

In R37, the composite material had high hydrolysis stability. When used as a thermal conductive filler, it could be used for a long time under high temperature and high humidity, and its thermal conductivity was basically unaffected.

### Experimental Examples

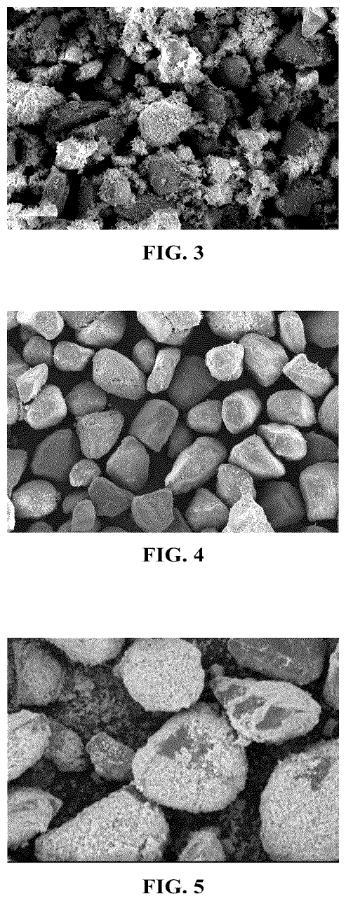

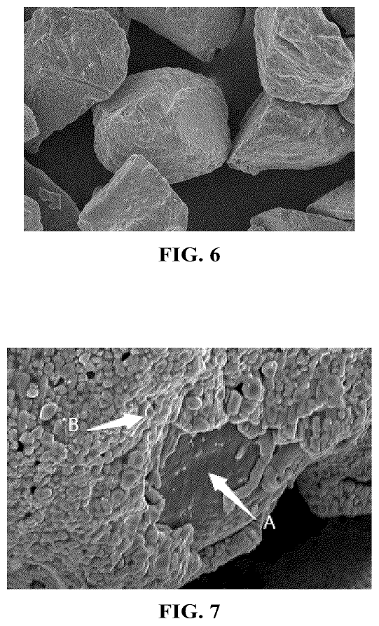

FIG. 3 is an SEM image (magnified 200 times) of the precursor in Example R1 of the present disclosure. FIG. 4 is an SEM image (magnified 200 times) of the composite material in Example R1 of the present disclosure. FIG. 5 is an SEM image (magnified 500 times) of the precursor in Example R21 of the present disclosure. FIG. 6 is an SEM image (magnified 500 times) of the composite material in Example R21 of the present disclosure. From the comparison of FIGS. 3 to 6, it can be seen that when the shell raw material before sintering coated the surface of the core, their relative uniformity was poor, complete coating was not easy, and the surface had a collection of many granular substances adhered to the surface of the core. After sintering, the shell uniformly coated the surface of the core, easily achieving complete coating, and achieving a continuous coating layer, which was a complete shell rather than a collection of granular substances adhered to the surface of the core. The inventors speculate that it might be that during the sintering process, the shell raw material magnesium oxide or zinc oxide could not only react with the core silicon carbide but also undergo mass transfer on the surface of the core. While forming a magnesium silicate or zinc silicate coating layer, the coating layer could be made more uniform, the coating effect was better, complete coating was easily achieved, and the comprehensive performance of the composite material was better.

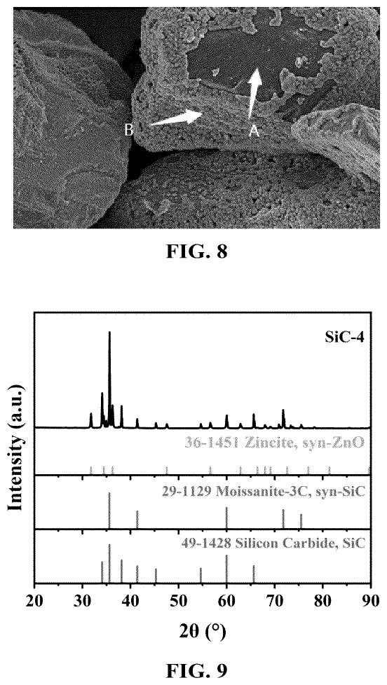

FIG. 7 is an SEM image (magnified 2000 times) of the composite material in Example R28 of the present disclosure. FIG. 8 is an SEM image (magnified 2000 times) of the composite material in Example R31 of the present disclosure. As can be seen from FIGS. 7 and 8, part of the core in region A was exposed and not completely covered by the shell B. The main reason was that the content of the shell raw material was small and the content of the coating aid was large, so that the shell material generated by the reaction was difficult to cover the entire surface of the core material.

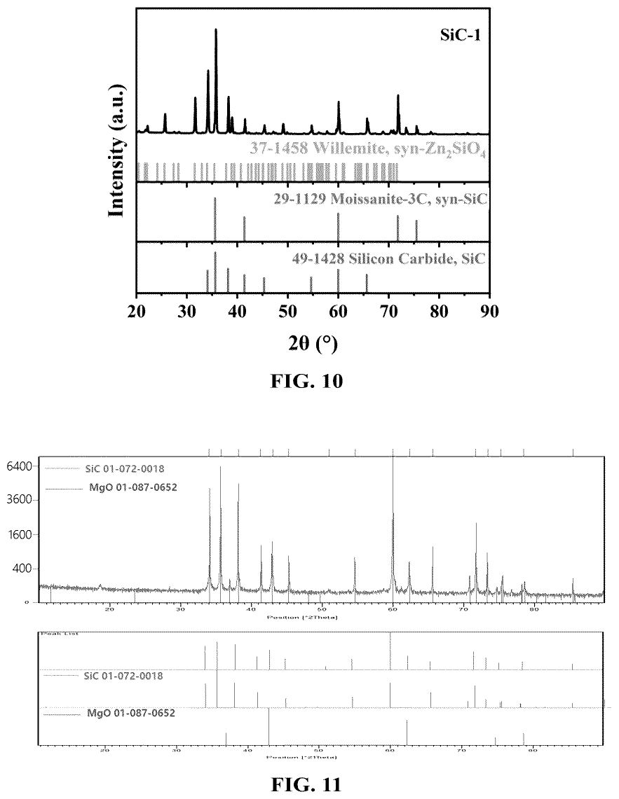

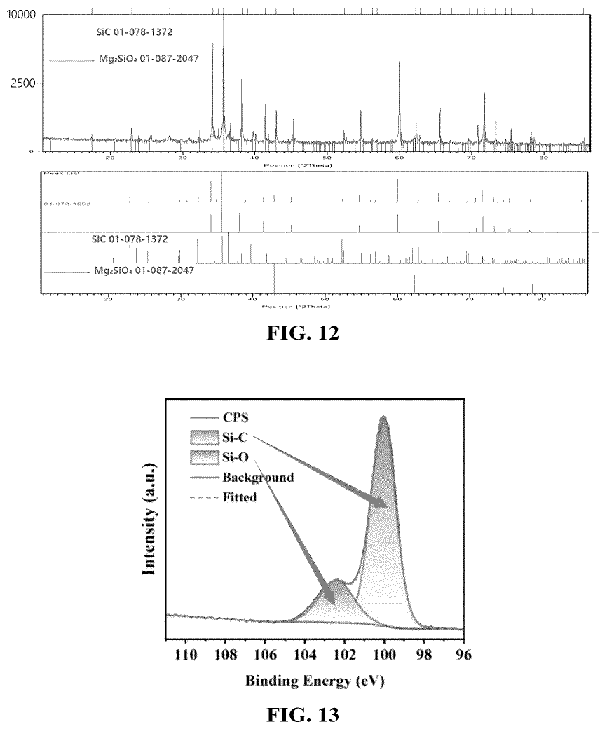

The composite material was subjected to XRD detection under the following conditions: copper target, tube voltage of 20 kV to 60 kV, tube current of 20 mA to 60 mA, goniometer radius of 185 mm, high-speed array detector. FIG. 9 is an XRD pattern of the precursor in Example R1 of the present disclosure. FIG. 10 is an XRD pattern of the composite material in Example R1 of the present disclosure. FIG. 11 is an XRD pattern of the precursor in Example R21 of the present disclosure. FIG. 12 is an XRD pattern of the composite material in Example R21 of the present disclosure. As can be seen from FIGS. 9 and 10, the surface of silicon carbide was coated with magnesium oxide before sintering, and was coated with magnesium silicate after sintering, indicating that magnesium oxide reacted to form magnesium silicate. The proportion of silicon carbide in the precursor was 86%, and the proportion of silicon carbide in the sintered composite material was 71%, indicating that the content of silicon carbide decreased after the reaction, and that silicon carbide participated in the synthesis of magnesium silicate through reaction during sintering. As can be seen from FIGS. 11 and 12, the surface of silicon carbide was coated with zinc oxide before sintering, and was coated with zinc silicate after sintering, indicating that zinc oxide reacted to form zinc silicate. The proportion of silicon carbide in the precursor was 65%, and the proportion of silicon carbide in the sintered composite material was 77%. When zinc oxide as the shell raw material accounted for 30% of the precursor, a large amount of shell raw material not coated on the surface of the core participated in the reaction, and the unreacted shell raw material were screened out before testing the performance of the composite material.

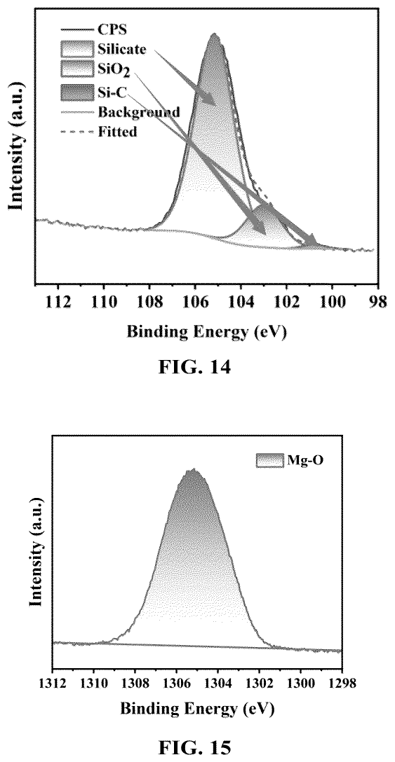

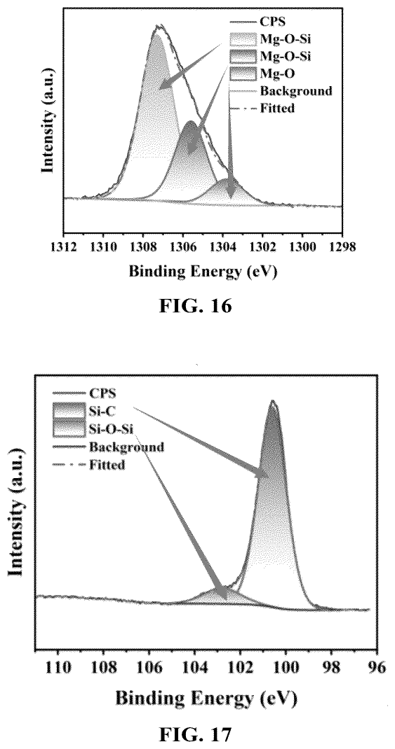

The composite material was subjected to XPS detection under the following conditions: acquisition time of 2 min 30.4 s, scanning times of 10, type Al—Kα, spot size of 500 μm, CAE transmission energy of 30.0 eV, energy step of 0.050 eV, and energy points of 301. The XPS spectra of the composite material were subjected to peak deconvolution. FIG. 13 is a peak-deconvoluted XPS Si2p spectrum analysis diagram of the precursor in Example R1 of the present disclosure; FIG. 14 is a peak-deconvoluted XPS Si2p spectrum analysis diagram of the composite material in Example R1 of the present disclosure; FIG. 15 is a peak-deconvoluted XPS Mg1s spectrum analysis diagram of the precursor in Example R1 of the present disclosure; and FIG. 16 is a peak-deconvoluted XPS Mg1s spectrum analysis diagram of the composite material in Example R1 of the present disclosure. As can be seen from FIGS. 13 to 16, the precursor before sintering contained Si—C chemical bonds with a bond binding energy of 100 eV to 101 eV, and Mg—O chemical bonds with a bond binding energy of 1303.9 eV to 1305 eV. The sintered composite material contained Si—C chemical bonds with a bond binding energy of 100 eV to 101 eV, O—Si—O chemical bonds with a bond binding energy of 105 eV to 106 eV, and Mg—O—Si chemical bonds with a bond binding energy of 1305.3 eV to 1306.7 eV, indicating that magnesium oxide was converted into magnesium silicate after sintering.

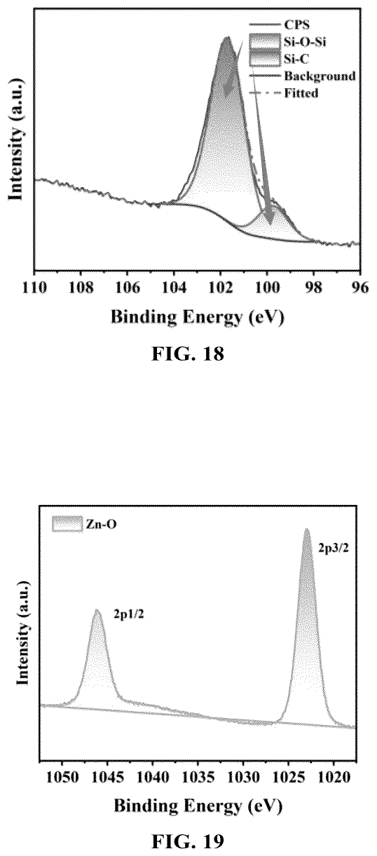

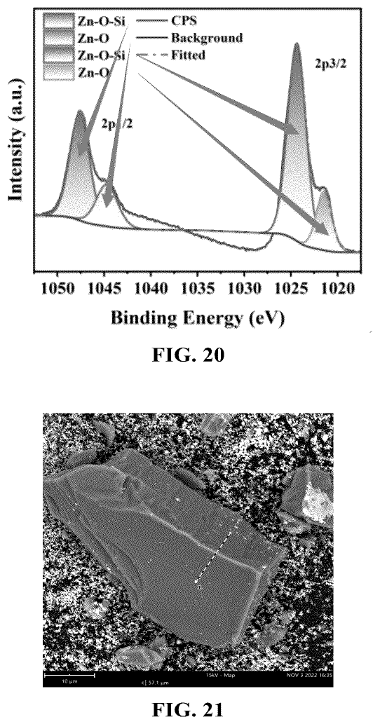

FIG. 17 is a peak-deconvoluted XPS Si2p spectrum analysis diagram of the precursor in Example R21 of the present disclosure; FIG. 18 is a peak-deconvoluted XPS Si2p spectrum analysis diagram of the composite material in Example R21 of the present disclosure; FIG. 19 is a peak-deconvoluted XPS Mg1s spectrum analysis diagram of the precursor in Example R21 of the present disclosure; and FIG. 20 is a peak-deconvoluted XPS Mg1s spectrum analysis diagram of the composite material in Example R21 of the present disclosure. As can be seen from FIGS. 17 to 20, the precursor before sintering contained Si—C chemical bonds with a bond binding energy of 100 eV to 101 eV, and Zn—O chemical bonds with a bond binding energy of 1022 eV to 1044 eV. The sintered composite material contained Si—C chemical bonds with a bond binding energy of 100 eV to 101 eV, and Zn—O—Si chemical bonds with a bond binding energy of 1022.6 eV to 1044.8 eV, indicating that magnesium oxide was converted into zinc silicate after sintering.

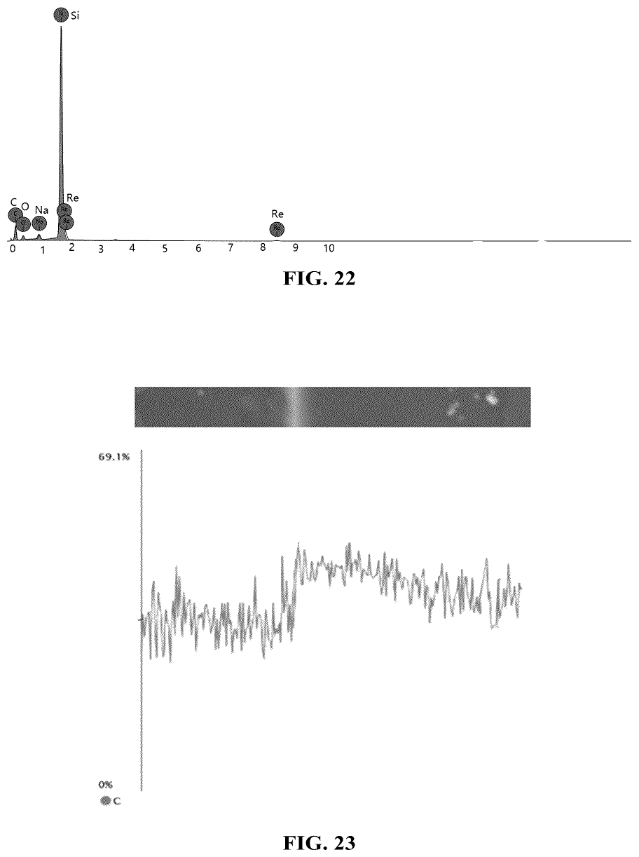

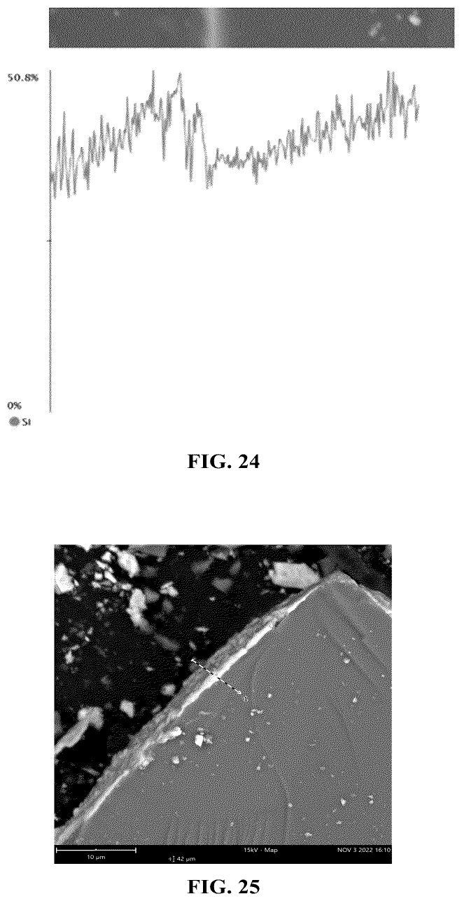

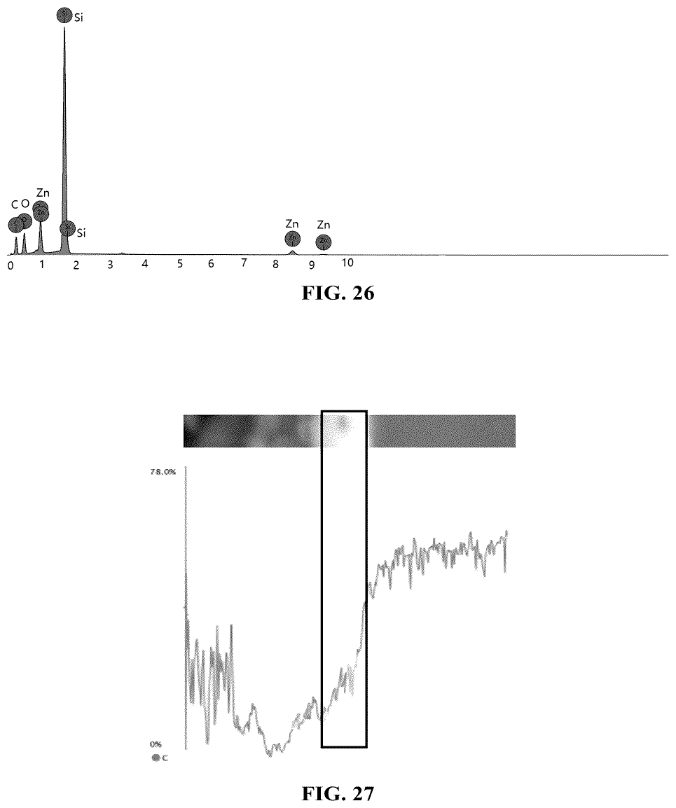

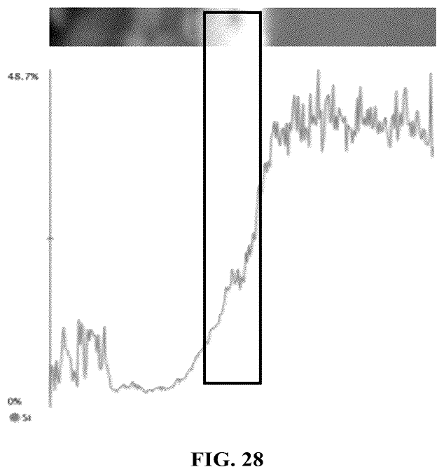

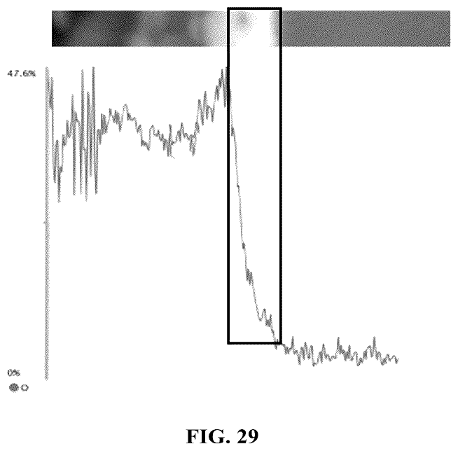

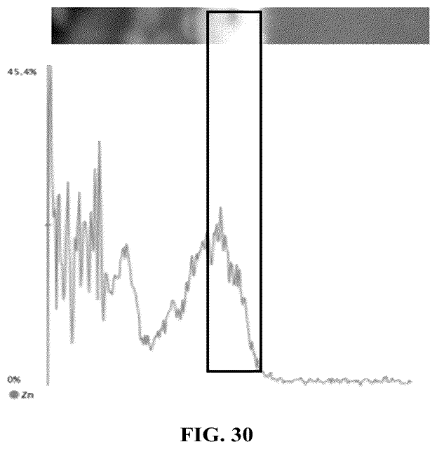

The test method for EDS is: FOV: 13.4 μm, Mode: 15 kV—Image, Detector: BSD Full. FIG. 21 shows the EDS line-scan direction (indicated by the arrow) of the precursor in Example R21 of the present disclosure; FIG. 22 is an EDS line-scan profile of the precursor in Example R21 of the present disclosure; FIG. 23 is a carbon-specific EDS line-scan profile of the precursor in Example R21 of the present disclosure; FIG. 24 is a silicon-specific EDS line-scan profile of the precursor in Example R21 of the present disclosure; FIG. 25 shows the EDS line-scan direction (indicated by the arrow) of the composite material in Example R21 of the present disclosure; FIG. 26 is an EDS line-scan profile of the composite material in Example R21 of the present disclosure; FIG. 27 is a carbon-specific EDS line-scan profile of the composite material in Example R21 of the present disclosure; FIG. 28 is a silicon-specific EDS line-scan profile of the composite material in Example R21 of the present disclosure; FIG. 29 is an oxygen-specific EDS line-scan profile of the composite material in Example R21 of the present disclosure; and FIG. 30 is a zinc-specific EDS line-scan profile of the composite material in Example R21 of the present disclosure. As can be seen from FIGS. 21 to 24, before the EDS test, the precursor was cut, and powder falling off during cutting caused the coating material to separate from the core. The finally obtained carbon-specific EDS line-scan profile and silicon-specific EDS line-scan profile were basically horizontal, and the content of silicon basically did not change, indirectly indicating that the bonding between the coating material and the core in the precursor was poor. As can be seen from FIGS. 25 to 30, before the EDS test, the precursor was cut, and a distinct shell and core were formed after cutting, with close contact and no gap between the shell and the core, and their crystal grains were directly connected, showing a good bonding effect of the two. At the same time, the obtained carbon-specific EDS line-scan profile and silicon-specific EDS line-scan profile showed a sudden increase in the middle of the curve (black box), while the oxygen-specific EDS line-scan profile and zinc-specific EDS line-scan profile showed a sudden decrease in the middle of the curve (black box). The element change was a continuous process without disconnection, indicating no gap between the shell and the core.

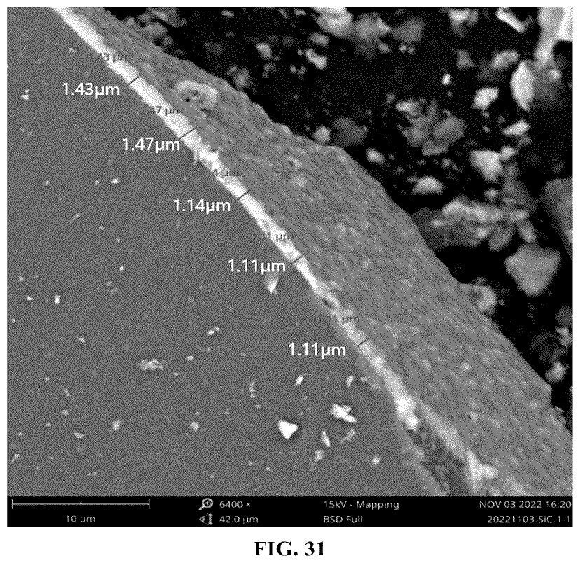

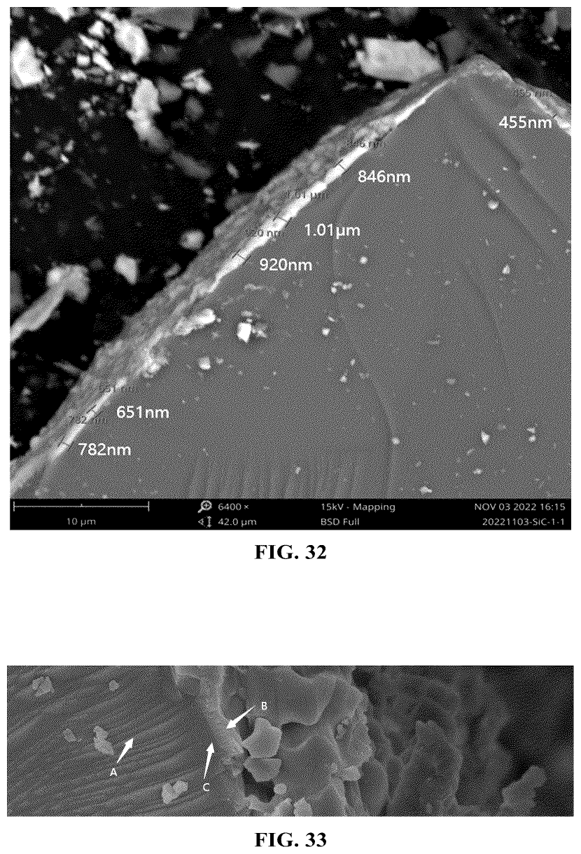

FIG. 31 is an SEM cross-section image (magnified 6400 times) of the composite material in Example R1 of the present disclosure; FIG. 32 is an SEM cross-section image (magnified 6400 times) of the composite material in Example R21 of the present disclosure; and FIG. 33 is an SEM cross-section image (magnified 60,000 times) of the composite material in Example R1 of the present disclosure. As can be seen from FIGS. 31 and 32, the shell and the core of the composite material provided by the present disclosure were tightly connected without gaps, and the crystal grains of the shell were connected to the crystal grains of the core, resulting in better performance of the obtained composite material. As can be seen from FIG. 33, even when the composite material was magnified 60,000 times, there was no gap between the core A and the shell B, but there was a certain transition layer C between the core A and the shell B, indicating that there was no gap between the core and the shell of the composite material provided by the present disclosure, the coating effect was better, and the obtained composite material had better performance.

Combining FIGS. 3, 4, 9 to 10, 13 to 16, 31 and 33, it can be seen that when preparing the composite material of magnesium silicate-coated silicon carbide, silicon carbide reacted with magnesium oxide to form magnesium silicate, so that there was no gap between silicon carbide and magnesium silicate. The magnesium silicate coating obtained by chemical reaction was a continuous coating. Due to the chemical reaction during sintering, the shell material was free of binder, and the magnesium silicate obtained after sintering was no longer a collection of multiple particles bonded to the surface of silicon carbide, but a complete shell, with the crystal grains of silicon carbide directly connected to those of magnesium silicate.

Combining FIGS. 5, 6, 11, 12, 17 to 30 and 32, it can be seen that when preparing the composite material of zinc silicate-coated silicon carbide, silicon carbide reacted with zinc oxide to form zinc silicate, so that there was no gap between silicon carbide and zinc silicate. The zinc silicate coating obtained by chemical reaction was a continuous coating. Due to the chemical reaction during sintering, the shell material was free of binder, and the zinc silicate obtained after sintering was no longer a collection of multiple particles bonded to the surface of silicon carbide, but a complete shell, with the crystal grains of silicon carbide directly connected to those of zinc silicate.

The embodiments described above represent only a portion of the embodiments of the present disclosure, and not all possible embodiments. The detailed description of the embodiments disclosed herein is provided solely to illustrate selected embodiments of the present disclosure, and is not intended to limit the scope of the present disclosure. Based on the embodiments disclosed herein, any other embodiments achievable by a person of ordinary skill in the art without inventive effort shall fall within the protection scope of the present disclosure.

What is claimed is:

1. A composite material, comprising a core and a shell coating the core, wherein a core material has a thermal conductivity of at least 20 W/(m·K), a shell material comprises a first metal salt, and the composite material satisfies following conditions:
the composite material has a D50₁ of A, and the composite material with a mass of M is placed in a container with a stirring device, stirred for 10 min with a filling ratio of 0.4 and a rotation speed of 500 r/min, then screened through a sieve of (0.1-0.3)×A, and an amount of screen underflow is not higher than 0.05×M.

2. A composite material, comprising a core and a shell coating the core, wherein a core material has a thermal conductivity of at least 20 W/(m·K), and a shell material comprises a first metal salt obtained by sintering.

3. A composite material, comprising a core and a shell coating the core, wherein a shell material comprises a first metal salt, a core material has a thermal conductivity of at least 20 W/(m·K), at least one element is common to both the core material and the shell material, and a transition layer is further provided between the core and the shell, a content of at least one element gradually decreases and a content of at least one element gradually increases from outside to inside in the transition layer.

4. The composite material according to claim 1, wherein the composite material satisfies one or more of following conditions:
(1) the composite material has a D50₁ of A, and the composite material with a mass of M is placed in a container with a stirring device, stirred with a filling ratio of 0.4 and a rotation speed of 500 r/min, then screened through a sieve of (0.1-0.3)×A, and an amount of screen underflow is not higher than 0.02×M;
(2) there is no gap between the core and the shell;
(3) the shell is a complete shell;
(4) the shell is a continuous coating layer;
(5) the composite material is free of binder;
(6) the shell is not a collection of multiple particles adhered to a surface of the core;
(7) crystal grains of the core are directly connected to crystal grains of the shell;
(8) the shell covers at least 85% of a surface of the core;
(9) a mass fraction of the core is not higher than 95%;
(10) the core material has a thermal conductivity of 20 W/(m·K) to 500 W/(m·K);
(11) the composite material has a D50₁ of at least 0.5 μm;
(12) the composite material has a D50₁ of 0.5 μm to 150 μm, and 0.5≤(D90₁−D10₁)/D50₁≤1.5;
(13) a ratio of a thickness of the shell to a particle size of the composite material is 0.02 to 0.1;
(14) the composite material has a tap density of at least 1.85 g/cm³; (15) the composite material has a specific surface area not higher than 4 m²/g.

5. The composite material according to claim 4, wherein the composite material satisfies one or more of following conditions:
(16) the shell completely covers the core;
(17) the mass fraction of the core is 60% to 75%;
(18) the core material has the thermal conductivity of 50 W/(m·K) to 250 W/(m·K);
(19) the composite material has the D50₁ of 0.5 μm to 500 μm;
(20) the composite material has the D50₁ of 0.5 μm to 20 μm, and 0.5≤(D90₁−D10₁)/D50₁≤1;
(21) the ratio of the thickness of the shell to the particle size of the composite material is 0.04 to 0.07;
(22) the composite material has the tap density of 1.90 g/cm³ to 2.30 g/cm³;
(23) the composite material has the specific surface area of 0.04 m²/g to 4 m²/g (24) the composite material has the D50₁ of 40 μm to 150 μm, and the composite material has the specific surface area of 0.04 m²/g to 0.06 m²/g.

6. The composite material according to claim 1, wherein at least one element is common to both the core material and the first metal salt.

7. The composite material according to claim 1, wherein the composite material satisfies one or more of following conditions:
(25) the core material is a semiconductor material, and the shell material is an insulating material;
(26) the core material is silicon carbide, and the first metal salt is a metal silicate;
(27) the core material is silicon carbide, and the silicon carbide exists as primary particles.

8. The composite material according to claim 1, wherein the composite material satisfies one or more of following conditions:
(28) the core material has a Mohs hardness of 7 to 10;
(29) the core material is silicon nitride, and the first metal salt is a metal silicate;
(30) the core material is silicon nitride, the first metal salt is a metal silicate, and the metal silicate comprises at least one selected from magnesium silicate, aluminum silicate, zinc silicate, zirconium silicate, magnesium zirconium silicate, aluminum zirconium silicate, and zinc zirconium silicate;
(31) the core material is aluminum nitride, and the shell material comprises aluminate;
(32) the core material is aluminum nitride, the shell material comprises aluminate, and the aluminate comprises at least one selected from magnesium aluminate, zinc aluminate, calcium aluminate, potassium aluminate, and aluminum silicate.

9. The composite material according to claim 1, wherein the core material is silicon carbide, the shell material further comprises a second metal salt containing at least two metal elements and free of silicon, and a mass fraction of the metal silicate in the shell material is at least 10%.

10. The composite material according to claim 9, wherein the composite material satisfies one or more of following conditions:
(33) a mass fraction of the metal silicate in the shell material is 20% to 90%;
(34) the second metal salt is aluminate and/or zirconate;
(35) the second metal salt comprises at least one selected from zinc aluminate, magnesium aluminate, calcium aluminate, potassium aluminate, zinc zirconate, magnesium zirconate, and calcium aluminate.

11. The composite material according to claim 9, wherein a mass fraction of the metal silicate in the shell material is 100%.

12. The composite material according to claim 1, wherein the composite material satisfies one or more of following conditions:
(36) the composite material has a D50₁ of 100 μm to 150 μm, the core material is silicon carbide, the shell material is magnesium silicate, and the composite material satisfies following conditions: 4.8 parts by weight of vinyl silicone oil with a viscosity of 100 mPa·s, 20 parts by weight of the composite material, 21 parts by weight of spherical alumina NSM-1S, 30 parts by weight of spherical alumina BAK-10, and 25 parts by weight of spherical alumina BAK-120 are mixed, first treated for 1 min at a rotation speed of 1100 r/min and a vacuum degree of 1000 Pa; then treated for 1 min at a rotation speed of 1500 r/min and a vacuum degree of 40 Pa; and using an Anton Paar rheometer at 25° C. and shear rates of 0.1 to 100 s⁻¹, a viscosity at 1 s⁻¹ is measured to be 1×10⁶ mPa·s to 1.6×10⁶ mPa·s;
(37) the core material is silicon carbide, the shell material is a metal silicate, and the composite material satisfies following conditions: an EDS test is performed on the composite material, and an EDS line scan is conducted from the shell to the core, obtained EDS curves of silicon, oxygen, and metal element are all continuous lines, and in a middle of the curves, a content of silicon suddenly increases, while a content of oxygen and a content of metal element suddenly decrease;
(38) the core material is silicon carbide, the shell material is magnesium silicate, and the composite material satisfies following conditions: after XPS test on the composite material and subsequent peak deconvolution, a peak-deconvoluted Si2p spectrum comprises Si—C bonds with a binding energy of 100 eV to 101 eV and O—Si—O bonds with a binding energy of 105 eV to 106 eV, and a peak-deconvoluted Mg1s spectrum comprises Mg—O—Si bonds with a binding energy of 1305 eV to 1307 eV;
(39) the core material is silicon carbide, the shell material is zinc silicate, and the composite material satisfies following conditions: after XPS test on the composite material and subsequent peak deconvolution, a peak-deconvoluted Si2p spectrum comprises Si—C bonds with a binding energy of 100 eV to 101 eV and O—Si—O bonds with a binding energy of 105 eV to 106 eV, and a peak-deconvoluted Zn1s spectrum comprises Zn—O—Si bonds with a binding energy of 1022 eV to 1045 eV.

13. A method for preparing the composite material according to claim 1, comprising:
coating a shell raw material on a surface of a core to form a precursor;
sintering the precursor to cause at least part of the shell raw material to undergo mass transfer on a surface of the core to form a shell containing a first metal salt, thereby obtaining the composite material, wherein
the core material has a thermal conductivity of at least 20 W/(m·K).

14. The method according to claim 13, wherein the method satisfies one or more of following conditions:
(40) the core has a tap density of at least 1.90 g/cm³;
(41) the core material has a thermal conductivity of 20 W/(m·K) to 500 W/(m·K);
(42) the shell raw material has a D50₂ of 0.05 μm to 10 μm, the core material has a D50₃ of 0.5 μm to 1000 μm, and 0.00001≤D50₂/D50₃≤0.1;
(43) a mass fraction of the shell raw material in the precursor is 1% to 30%;
(44) the core material is silicon nitride or silicon carbide, and the shell raw material comprises at least one selected from magnesium, magnesium oxide, magnesium hydroxide, organic magnesium, aluminum, aluminum oxide, aluminum hydroxide, organic aluminum, zinc, zinc oxide, zinc hydroxide, organic zinc, zirconium, zirconium oxide, zirconium hydroxide, and organic zirconium, wherein during the sintering, at least part of the shell raw material reacts with the core and undergoes mass transfer to form the shell containing the first metal salt;
(45) the core material is silicon carbide, and the silicon carbide exists as primary particles;
(46) the core material is aluminum nitride, and the shell raw material comprises at least one selected from zinc oxide, magnesium oxide, calcium oxide, potassium oxide, and silicon oxide, wherein during the sintering, at least part of the shell raw material reacts with the core and undergoes mass transfer to form the shell containing the first metal salt;
(47) the core material is silicon nitride or silicon carbide, and the shell raw material comprises hydrated silicate, wherein during the sintering, at least part of the hydrated silicate melts and undergoes mass transfer on the surface of the core to form the shell containing a silicate;
(48) a method for forming the precursor comprises: mixing the core, the shell raw material, and a coating aid, and then performing coating.

15. The method according to claim 14, wherein the method satisfies one or more of following conditions:
(49) the core has the tap density of 1.90 g/cm³ to 2.4 g/cm³;
(50) the core material has the thermal conductivity of 50 W/(m·K) to 250 W/(m·K);
(51) the core material has the D50₃ of 0.5 μm to 140 μm, and 0.0003≤D50₂/D50₃≤0.1;
(52) the mass fraction of the shell raw material in the precursor is 5% to 20%;
(53) the core material is silicon nitride or silicon carbide, and the shell raw material comprises at least one selected from magnesium, magnesium oxide, magnesium hydroxide, aluminum, aluminum oxide, aluminum hydroxide, zinc, zinc oxide, zinc hydroxide, zirconium, zirconium oxide, and zirconium hydroxide, wherein during the sintering, at least part of the hydrated silicate melts and undergoes mass transfer on the surface of the core to form the shell containing a silicate;
(54) the core material is silicon nitride or silicon carbide, the shell raw material comprises at least one selected from magnesium oxide, aluminum oxide, zinc oxide, and zirconium oxide, and the sintering is performed at a temperature of 1000° C. to 1400° C. for 3 h to 8 h;
(55) the core material is aluminum nitride, the shell raw material comprises at least one selected from zinc oxide, magnesium oxide, calcium oxide, potassium oxide, and silicon oxide, and the sintering is performed at a temperature of 1400° C. to 1800° C. for 3 h to 8 h;
(56) the core material is silicon nitride or silicon carbide, the shell raw material comprises hydrated silicate, and the hydrated silicate comprises one or more of hydrated magnesium silicate, hydrated sodium silicate, hydrated sodium aluminosilicate, and hydrated calcium aluminosilicate;
(57) the core material is silicon nitride or silicon carbide, the shell raw material comprises hydrated silicate, and the sintering is performed at a temperature higher than a melting point of at least part of the hydrated silicate for 3 h to 8 h;
(58) the core material is silicon nitride or silicon carbide, and the coating aid comprises a coating aid containing silicon.

16. The method according to claim 15, wherein the method satisfies one or more of following conditions:
(59) the coating aid comprises tetraethyl orthosilicate;
(60) a mass fraction of the coating aid in the precursor is 1% to 15%;
(61) the coating is performed by wet ball milling at a rotation speed of 200 r/min to 600 r/min for at least 1 h.

17. The method according to claim 16, wherein the method satisfies one or more of following conditions:
(62) a mass fraction of the coating aid in the precursor is 3% to 10%;
(63) the rotation speed of the wet ball milling is 300 r/min to 500 r/min, and a duration of the wet ball milling is 1 h to 6 h.

18. The composite material according to claim 2, wherein the composite material satisfies one or more of following conditions:
(1) the composite material has a D50₁ of A, and the composite material with a mass of M is placed in a container with a stirring device, stirred with a filling ratio of 0.4 and a rotation speed of 500 r/min, then screened through a sieve of (0.1-0.3)×A, and an amount of screen underflow is not higher than 0.02×M;
(2) there is no gap between the core and the shell;
(3) the shell is a complete shell;
(4) the shell is a continuous coating layer;
(5) the composite material is free of binder;
(6) the shell is not a collection of multiple particles adhered to a surface of the core;
(7) crystal grains of the core are directly connected to crystal grains of the shell;
(8) the shell covers at least 85% of a surface of the core;
(9) a mass fraction of the core is not higher than 95%;
(10) the core material has a thermal conductivity of 20 W/(m·K) to 500 W/(m·K);
(11) the composite material has a D50₁ of at least 0.5 μm;
(12) the composite material has a D50₁ of 0.5 μm to 150 μm, and 0.5≤(D90₁−D10₁)/D50₁≤1.5;
(13) a ratio of a thickness of the shell to a particle size of the composite material is 0.02 to 0.1;
(14) the composite material has a tap density of at least 1.85 g/cm³;
(15) the composite material has a specific surface area not higher than 4 m²/g.

19. The composite material according to claim 3, wherein the composite material satisfies one or more of following conditions:
(1) the composite material has a D50₁ of A, and the composite material with a mass of M is placed in a container with a stirring device, stirred with a filling ratio of 0.4 and a rotation speed of 500 r/min, then screened through a sieve of (0.1-0.3)×A, and an amount of screen underflow is not higher than 0.02×M;
(2) there is no gap between the core and the shell;
(3) the shell is a complete shell;
(4) the shell is a continuous coating layer;
(5) the composite material is free of binder;
(6) the shell is not a collection of multiple particles adhered to a surface of the core;
(7) crystal grains of the core are directly connected to crystal grains of the shell;
(8) the shell covers at least 85% of a surface of the core;
(9) a mass fraction of the core is not higher than 95%;
(10) the core material has a thermal conductivity of 20 W/(m·K) to 500 W/(m·K);
(11) the composite material has a D50₁ of at least 0.5 μm;
(12) the composite material has a D50₁ of 0.5 μm to 150 μm, and 0.5≤(D90₁−D10₁)/D50₁≤1.5;
(13) a ratio of a thickness of the shell to a particle size of the composite material is 0.02 to 0.1;
(14) the composite material has a tap density of at least 1.85 g/cm³;
(15) the composite material has a specific surface area not higher than 4 m²/g.

20. The composite material according to claim 2, wherein the composite material satisfies one or more of following conditions:
(25) the core material is a semiconductor material, and the shell material is an insulating material;
(26) the core material is silicon carbide, and the first metal salt is a metal silicate;
(27) the core material is silicon carbide, and the silicon carbide exists as primary particles.
